(19) United States
(12) Patent Application Publication
(10) Pub. No.: US 2025/0300938 A1
(43) Pub. Date: Sep. 25, 2025

(54) SERVICE DATA PROCESSING METHOD AND APPARATUS, DEVICE, AND MEDIUM

(71) Applicant: Tencent Technology (Shenzhen) Company Limited, Shenzhen (CN)

(72) Inventors: Xuechun LI, Shenzhen (CN); Yanchun LIN, Shenzhen (CN); Fan YANG, Shenzhen (CN); Weihong LUO, Shenzhen (CN); Di WU, Shenzhen (CN); Haihua LIN, Shenzhen (CN); Xing ZHANG, Shenzhen (CN)

(73) Assignee: Tencent Technology (Shenzhen) Company Limited, Shenzhen (CN)

(21) Appl. No.: 19/229,046

(22) Filed: Jun. 5, 2025

Related U.S. Application Data
(63) Continuation of application No. PCT/CN2024/085342, filed on Apr. 1, 2024.

(30) Foreign Application Priority Data
May 22, 2023 (CN) 202310583288.9

(51) Int. Cl. H04L 47/2408; H04L 67/55

(52) U.S. Cl. CPC H04L 47/2408; H04L 67/55

(57) ABSTRACT

A service data processing method, apparatus, and computer-readable storage medium for allocating traffic among multiple services. The method includes acquiring N services and M indicator sampling values corresponding to these services, where M and N are integers greater than 1. Based on indicator sampling values satisfying a recommendation constraint, recommendation probabilities are determined for each service. A first traffic allocation proportion is calculated based on the ratio of each service's recommendation probability to the total accumulated recommendation probability. A second traffic allocation proportion is then determined using a weighted summation of the first allocation proportion and a reference allocation proportion. The N services are pushed on a platform according to this second traffic allocation proportion, with the reference allocation proportion being based on indicator sampling values not satisfying the recommendation constraint.

### CROSS-REFERENCE TO RELATED APPLICATIONS

The disclosure is a continuation application of International Application No. PCT/CN2024/085342 filed on Apr. 1, 2024 which claims priority to Chinese Patent Application No. 202310583288.9, filed with the China National Intellectual Property Administration on May 22, 2023, the disclosures of each being incorporated by reference herein in their entireties.

### FIELD

The disclosure relates to the technical field of the Internet, a service data processing method and apparatus, a device, and a medium.

### BACKGROUND

In the related art, when a platform has a plurality of to-be-recommended services (such as information A and information B), corresponding traffic may be allocated to each to-be-recommended service, to ensure that the to-be-recommended services can be exposed and converted properly. Currently, service personnel usually allocate corresponding traffic to each to-be-recommended service based on service historical data (such as a historical exposure rate and a historical conversion rate), and push the to-be-recommended service to a corresponding object according to a traffic allocation result corresponding to each to-be-recommended service. For example, a higher historical conversion rate of the to-be-recommended service itself or a higher historical conversion rate of a service of a same type may indicate more traffic allocated to the to-be-recommended service. However, each to-be-recommended service may face a problem of traffic saturation. When the traffic is allocated based on the service historical data of the to-be-recommended service or the service historical data of the service of the same type, the traffic may be excessively concentrated on to-be-recommended services that already reach or are about to reach traffic saturation, and only little traffic may be allocated to a to-be-recommended service that does not reach traffic saturation, resulting in excessively low traffic utilization.

### SUMMARY

Provided are a service data processing method and apparatus, a device, a storage medium, and a program product, which can implement efficient traffic allocation for multiple services based on indicator sampling values and recommendation probabilities.

According to some embodiments, a service data processing method, performed by a computer device, includes: acquiring N services and M indicator sampling values corresponding to the N services, M and N being integers greater than 1; determining, based on the M indicator sampling values satisfying a recommendation constraint, recommendation probabilities corresponding to the N services; determining a first traffic allocation proportion corresponding to each of the N services, based on a ratio of the recommendation probability corresponding to each of the N services to a total accumulated recommendation probability corresponding to the N services; determining a second traffic allocation proportion corresponding to each of the N services based on a weighted summation on the first traffic allocation proportion and a reference allocation proportion; and pushing the N services on a platform based on the second traffic allocation proportion, wherein the traffic reference allocation proportion is a traffic allocation proportion adopted by each of the N services based on at least one indicator sampling value not satisfying the recommendation constraint.

According to some embodiments, a service data processing apparatus, includes: at least one memory configured to store program code; and at least one processor configured to read the program code and operate as instructed by the program code, the program code including: acquiring code configured to cause at least one of the at least one processor to acquire N services and M indicator sampling values corresponding to the N services, M and N being integers greater than 1; determining code configured to cause at least one of the at least one processor to determine, based on the M indicator sampling values satisfying a recommendation constraint, recommendation probabilities corresponding to the N services; first allocation code configured to cause at least one of the at least one processor to determine a first traffic allocation proportion corresponding to each of the N services, based on a ratio of the recommendation probability corresponding to each of the N services to a total accumulated recommendation probability corresponding to the N services; second allocation code configured to cause at least one of the at least one processor to determine a second traffic allocation proportion corresponding to each of the N services based on a weighted summation on the first traffic allocation proportion and a reference allocation proportion; and pushing code configured to cause at least one of the at least one processor to push the N services on a platform based on the second traffic allocation proportion, wherein the traffic reference allocation proportion is a traffic allocation proportion adopted by each of the N services based on at least one indicator sampling value not satisfying the recommendation constraint.

According to some embodiments, a non-transitory computer-readable storage medium, storing computer code which, when executed by at least one processor, causes the at least one processor to at least: acquire N services and M indicator sampling values corresponding to the N services, M and N being integers greater than 1; determine, based on the M indicator sampling values satisfying a recommendation constraint, recommendation probabilities corresponding to the N services; determine a first traffic allocation proportion corresponding to each of the N services, based on a ratio of the recommendation probability corresponding to each of the N services to a total accumulated recommendation probability corresponding to the N services; determine a second traffic allocation proportion corresponding to each of the N services based on a weighted summation on the first traffic allocation proportion and a reference allocation proportion; and push the N services on a platform based on the second traffic allocation proportion, wherein the traffic reference allocation proportion is a traffic allocation proportion adopted by each of the N services based on at least one indicator sampling value not satisfying the recommendation constraint.

### BRIEF DESCRIPTION OF THE DRAWINGS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

FIG. 1 is a schematic structural diagram of a network architecture according to some embodiments.

FIG. 2 is a schematic diagram of a service recommendation scene according to some embodiments.

FIG. 3 is a schematic flowchart of a data processing method according to some embodiments.

FIG. 4 is a schematic diagram of correction of a probability distribution according to some embodiments.

FIG. 5 is a schematic diagram of an interface for pushing a service according to some embodiments.

FIG. 6 is a schematic diagram of another interface for pushing a service according to some embodiments.

FIG. 7 is a schematic flowchart of another data processing method according to some embodiments.

FIG. 8 is a schematic flowchart of calculation of an offloading proportion according to some embodiments.

FIG. 9 is a schematic structural diagram of a service data processing apparatus according to some embodiments.

FIG. 10 is a schematic structural diagram of a computer device according to some embodiments.

### DESCRIPTION OF EMBODIMENTS

The technical solutions in some embodiments are clearly and completely described below with reference to the accompanying drawings in some embodiments. Apparently, the described embodiments are merely some rather than all of some embodiments. All other embodiments derived by those of ordinary skill in the art from some embodiments in the disclosure without involving creative efforts fall within the scope of protection of the disclosure.

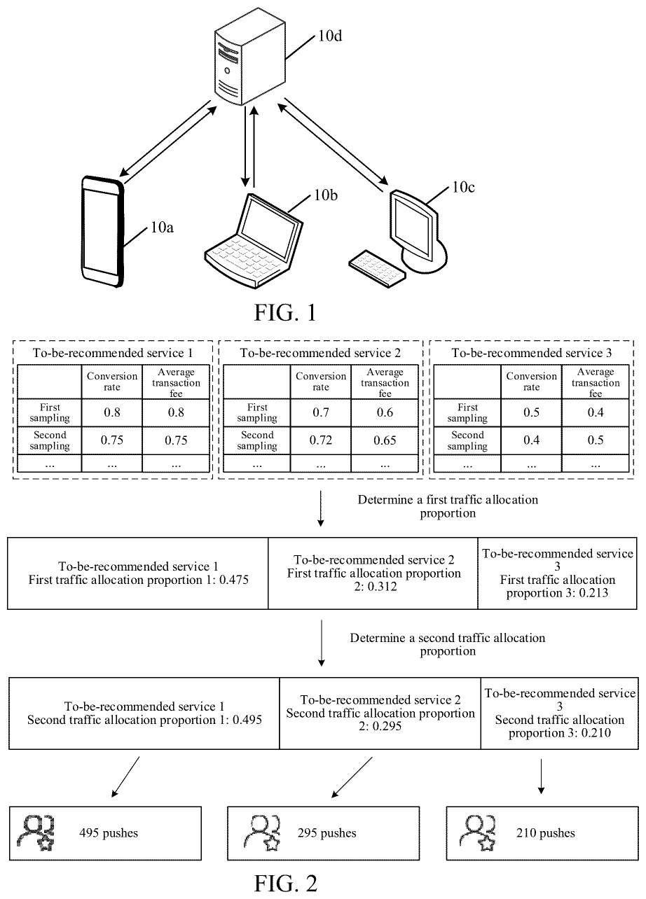

FIG. 1 is a schematic structural diagram of a network architecture according to some embodiments. The network architecture may include a server 10d and a terminal cluster. The terminal cluster may include one or more terminal devices. A number of terminal devices included in the terminal cluster is not limited herein. As shown in FIG. 1, the terminal cluster may include a terminal device 10a, a terminal device 10b, a terminal device 10c, and the like. All terminal devices in the terminal cluster (for example, may include the terminal device 10a, the terminal device 10b, and the terminal device 10c) may be connected to the server 10d through a network, whereby each terminal device can exchange data with the server 10d through the network connection.

The server 10d shown in FIG. 1 may be an independent physical server, or may be a server cluster or distributed system formed by a plurality of physical servers, or may be a cloud server that provides a cloud computing service such as a cloud service, a cloud database, cloud computing, a cloud function, cloud storage, a network service, cloud communication, a middleware service, a domain name service, a security service, a content distribution network (CDN), and a big data and artificial intelligence platform. A type of the server is not limited in the disclosure.

The terminal device in the terminal cluster shown in FIG. 1 may include, but is not limited to, an electronic device such as a smartphone, a tablet computer, a notebook computer, a palmtop computer, a mobile Internet device (MID), a wearable device (such as a smart watch or a smart band), an intelligent voice interaction device, a smart home appliance (such as a smart television), an on-board device, and an aircraft. A type of the terminal device is not limited the disclosure.

Each terminal device in the terminal cluster shown in FIG. 1 may be integrated with a service platform. The service platform may be an application client, a web page, an applet, or the like that can push a service. When running on the terminal devices, the service platforms can respectively exchange data with the server 10d shown in FIG. 1. For example, when the service platform is an application client, the service platforms running on the terminal devices may be independent clients, or may be embedded sub-clients integrated in a client. This is not limited in some embodiments.

In some embodiments, when the service platform is an application client, the service platform may include, but is not limited to, an on-board client, a smart home client, an entertainment client (such as a game client), a multi-media client (such as a video client or a music client), an interactive client, an information client (such as a news client), and the like. If the terminal device included in the terminal cluster is an on-board device, the on-board device may be an intelligent terminal in an intelligent transportation scene, and an application client running on the on-board device may be referred to as an on-board client.

In some embodiments, the server 10d and the terminal devices (such as the terminal device 10a, the terminal device 10b, and the terminal device 10c) may independently implement the service data processing method provided in some embodiments. In some embodiments, the server 10d and the terminal devices (such as the terminal device 10a, the terminal device 10b, and the terminal device 10c) may cooperatively implement the service data processing method provided in some embodiments. This is not limited in the disclosure.

FIG. 2 is a schematic diagram of a service recommendation scene according to some embodiments. As shown in FIG. 2, in the service recommendation scene, it is assumed that a plurality of services may be pushed on a service platform, the plurality of services that may be pushed may be referred to as to-be-recommended services, such as a to-be-recommended service 1, a to-be-recommended service 2, and a to-be-recommended service 3 shown in FIG. 1. Before the to-be-recommended services are pushed on the service platform, traffic may be allocated to each to-be-recommended service. A conversion rate and an average transaction fee may be selected as optimization indicators of the to-be-recommended service 1, the to-be-recommended service 2, and the to-be-recommended service 3, and then corresponding recommendation constraints are respectively designed for the conversion rate indicator and the average transaction fee indicator. The conversion rate may be a ratio of a number of times that the to-be-recommended service is purchased or subscribed to a total number of pushes; and the average transaction fee may be a ratio of a total transaction fee of the to-be-recommended service to a number of transactions.

For example, the recommendation constraint corresponding to the conversion rate indicator may be designed as that “an indicator sampling value corresponding to the conversion rate indicator satisfies the recommendation constraint when greater than or equal to 0.78, and otherwise does not satisfy the recommendation constraint”. The recommendation constraint corresponding to the average transaction fee indicator may be designed as that “an indicator sampling value corresponding to the average transaction fee indicator satisfies the recommendation constraint when greater than or equal to 0.6, and otherwise does not satisfy the recommendation constraint”. As shown in FIG. 2, the foregoing examples are taken as the recommendation constraints of the conversion rate indicator and the average transaction fee indicator. It is assumed that in the first sampling, for the to-be-recommended service 1, the indicator sampling value corresponding to the conversion rate indicator is 0.8, and the indicator sampling value corresponding to the average transaction fee indicator is 0.6. For the to-be-recommended service 2, the indicator sampling value corresponding to the conversion rate indicator is 0.7, and the indicator sampling value corresponding to the average transaction fee indicator is 0.6. For the to-be-recommended service 3, the indicator sampling value corresponding to the conversion rate indicator is 0.5, and the indicator sampling value corresponding to the average transaction fee indicator is 0.4. By comparing the indicator sampling value of the to-be-recommended service 1 for the conversion rate indicator with the recommendation constraint corresponding to the conversion rate indicator, it may be determined that the indicator sampling value of the to-be-recommended service 1 for the conversion rate indicator satisfies the recommendation constraint corresponding to the conversion rate indicator. By comparing the indicator sampling value of the to-be-recommended service 1 for the average transaction fee indicator with the recommendation constraint corresponding to the average transaction fee indicator, it may be determined that the indicator sampling value of the to-be-recommended service 1 for the average transaction fee indicator also satisfies the recommendation constraint corresponding to the average transaction fee indicator. Therefore, in the first sampling, the two indicator sampling values corresponding to the to-be-recommended service 1 in the three to-be-recommended services both satisfy the recommendation constraints, and further, it may be determined that the first sampling passes the constraint. In this case, a constraint compliance time may be updated to 1 (an initial value thereof is 0).

Similarly, in the second sampling, by comparing the indicator sampling value of each to-be-recommended service for the conversion rate indicator with the recommendation constraint corresponding to the conversion rate indicator, and comparing the indicator sampling value of each to-be-recommended service for the average transaction fee indicator with the recommendation constraint corresponding to the average transaction fee indicator, it may be determined that at least one of the two indicator sampling values corresponding to the to-be-recommended service 1, at least one of the two indicator sampling values corresponding to the to-be-recommended service 2, and at least one of the two indicator sampling values corresponding to the to-be-recommended service 3 do not satisfy the indicator sampling value of the recommendation constraint. For example, the to-be-recommended service 1 and the to-be-recommended service 2 do not satisfy the recommendation constraint corresponding to the conversion rate indicator, and the to-be-recommended service 3 does not satisfy the recommendation constraint corresponding to the conversion rate indicator and the recommendation constraint corresponding to the average transaction fee. Further, it may be determined that the second sampling fails to pass the constraint. In this case, a constraint violation time may be updated to 1 (an initial value thereof is 0). The foregoing process is repeated until a preset total sampling time is reached (for example, the total sampling time is set to 10000).

After the total sampling time is reached, recommendation probabilities corresponding to the to-be-recommended service 1, the to-be-recommended service 2, and the to-be-recommended service 3 may be calculated according to the constraint compliance time, a sum of the recommendation probabilities corresponding to the to-be-recommended service 1, the to-be-recommended service 2, and the to-be-recommended service 3 is determined as an accumulated recommendation probability, and further, a first traffic allocation proportion corresponding to each to-be-recommended service is determined according to a proportion of the recommendation probability corresponding to each to-be-recommended service in the accumulated recommendation probability. As shown in FIG. 2, a first traffic allocation proportion 1 corresponding to the to-be-recommended service 1 may be 0.475, a first traffic allocation proportion 2 corresponding to the to-be-recommended service 2 may be 0.312, and a first traffic allocation proportion 3 corresponding to the to-be-recommended service 3 may be 0.213.

Further, weighted summation may be performed on the first traffic allocation proportion corresponding to each to-be-recommended service and a traffic reference allocation proportion, to obtain a second traffic allocation proportion corresponding to each to-be-recommended service. In a process of weighted summation, a weight of the first traffic allocation proportion may be associated with the constraint compliance time and the total sampling time, and a weight of the traffic reference allocation proportion may be associated with the constraint violation time and the total sampling time. The traffic reference allocation proportion refers to a traffic allocation proportion adopted by each to-be-recommended service when each to-be-recommended service has an indicator sampling value that does not satisfy the recommendation constraint. A method for determining the traffic reference allocation proportion is described in detail in subsequent content. As shown in FIG. 2, the to-be-recommended service 1 may finally obtain a second traffic allocation proportion 1 of 0.495, the to-be-recommended service 2 may finally obtain a second traffic allocation proportion 2 of 0.295, and the to-be-recommended service 3 may finally obtain a second traffic allocation proportion 3 of 0.210. Further, recommendation traffic may be allocated to each to-be-recommended service according to the second traffic allocation proportion corresponding to each to-be-recommended service. For example, if the total recommendation traffic provided by the service platform for this service push is 1000 pushes, according to the second traffic allocation proportion, the to-be-recommended service 1 may obtain recommendation traffic of 495 pushes, the to-be-recommended service 2 may obtain recommendation traffic of 295 pushes, and the to-be-recommended service 3 may obtain recommendation traffic of 210 pushes. In this case, the to-be-recommended service 1 may be pushed to 495 registered objects on the service platform, the to-be-recommended service 2 may be pushed to 295 registered objects on the service platform, and the to-be-recommended service 3 may be pushed to 210 registered objects on the service platform.

In some embodiments, in a process of allocating traffic to the plurality of to-be-recommended services, the plurality of indicators are set for the plurality of to-be-recommended services, and the corresponding recommendation constraint may be configured for each indicator. The plurality of indicators and the recommendation constraint corresponding to each indicator are taken as comprehensive considerations in traffic allocation, whereby rationality of the final traffic allocation proportion of each to-be-recommended service may be improved, and further, traffic utilization of the plurality of to-be-recommended services may be improved.

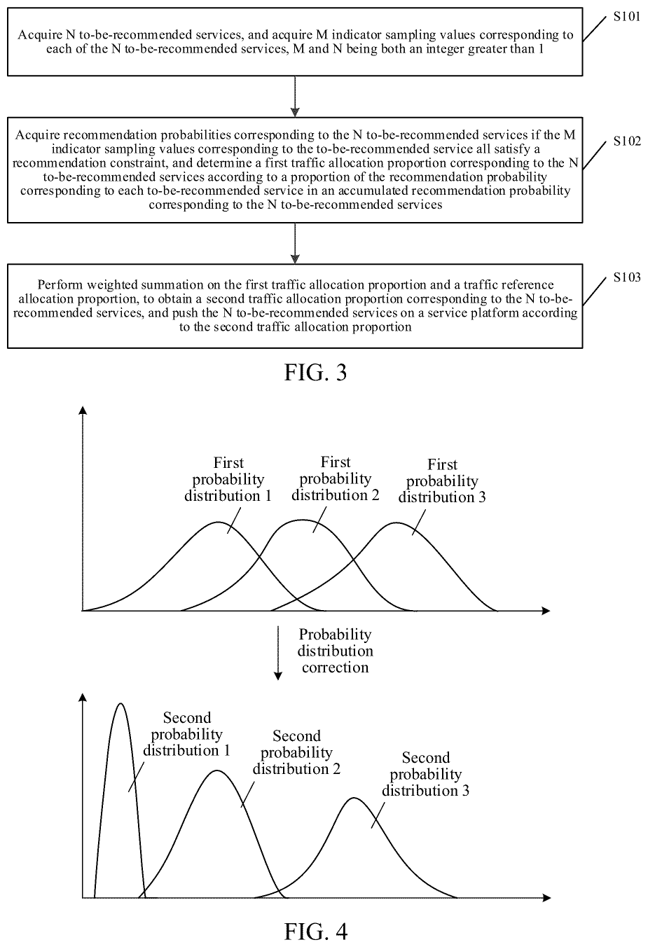

FIG. 3 is a schematic flowchart of a service data processing method according to some embodiments. The data processing method is performed by a computer device, and the computer device may be a terminal device (such as the terminal device 10a, the terminal device 10b, and the terminal device 10c in some embodiments corresponding to FIG. 1), or a server (such as the server 10d in some embodiments corresponding to FIG. 1). As shown in FIG. 3, the service data processing method may include operation S101 to operation S103.

Operation S101: Acquire N to-be-recommended services, and acquire M indicator sampling values corresponding to each of the N to-be-recommended services, M and N being each an integer greater than 1.

The to-be-recommended service may be understood as information that may be pushed to a service object through a service platform, and may include to-be-pushed advertisements, games, information, videos, props, commodities, and the like. The service platform may be understood as an application client, a web page, an applet, or the like that can push a service, such as a video client, an information web page, or a game applet. N indicates a number of to-be-recommended services, and is an integer greater than 1. A value of N may be 2, 3, 4, or the like. In other words, in some embodiments, at least two to-be-recommended services are acquired.

The to-be-recommended service is provided by a service party, and the service party may be an object that provides the to-be-recommended service, such as a shopping platform, an information platform, or an activity display platform. Service types of the to-be-recommended services may be the same or different. This is not limited in some embodiments. For example, the N to-be-recommended services include two to-be-recommended services (which are a to-be-recommended service 1 and a to-be-recommended service 2, respectively). If the to-be-recommended service 1 is advertisement information of a lipstick of a brand A, and the to-be-recommended service 2 is advertisement information of a camera of a brand B, it may be determined that service types of the to-be-recommended service 1 and the to-be-recommended service 2 are the same (both are advertisement information). If the to-be-recommended service 1 is information of social news, and the to-be-recommended service 2 is advertisement information of the camera of the brand B, it may be determined that the service types of the to-be-recommended service 1 and the to-be-recommended service 2 are different. The to-be-recommended service may be information that has been pushed on the service platform, for example, information that has been exposed on the service platform, or may be new information that has not been pushed on the service platform yet, for example, information that has not been exposed on the service platform yet. The to-be-recommended service may be stored in a service database corresponding to the service platform, and the service database may be a local database, a cloud database, a backend server corresponding to the service platform, or the like. The service database may be configured with at least one type of query interface, such as an Oracle (a relational database management system) interface, and a Structured Query Language (SQL) Server (a relational database management system) interface. When the to-be-recommended service may be pushed on the service platform, a corresponding query result is invoked by using a programming language, to acquire the to-be-recommended service from the service database.

The indicator sampling value may refer to a result obtained by randomly sampling the to-be-recommended service for one or more times for each indicator. For a single to-be-recommended service, in each sampling (one sampling may include one or more random sampling), one indicator corresponds to one indicator sampling value. If M indicators are set for the to-be-recommended service, in each sampling, one to-be-recommended service may correspond to M indicator sampling values. Herein, M indicates a number of indicators, and is an integer greater than 1. For example, a value of M may be 2, 3, 4, or the like. An actual benefit generated after each to-be-recommended service is pushed on the service platform is unknown at a current moment. Therefore, an expected benefit of each to-be-recommended service may be estimated through sampling. The estimated expected benefit of each to-be-recommended service may be updated based on the indicator sampling value, which plays an important role in subsequent calculation of the second traffic allocation proportion corresponding to each to-be-recommended service. In some embodiments, one to-be-recommended service (such as a to-be-recommended service i) may correspond to M indicator sampling values, and the M indicator sampling values may be denoted as I={I_{1(Arm}_{ᵢ}₎, I_{2(Arm}_{ᵢ}₎, . . . , I_{j(Arm}_{ᵢ}₎, . . . , I_{M(Arm}_{ᵢ}₎}, where I_{j(Arm}_{ᵢ}₎ indicates an indicator sampling value of the to-be-recommended service i for the j^{th} indicator, and j is a positive integer less than or equal to M.

In some embodiments, M indicators associated with the N to-be-recommended services may be acquired, and further, indicator sampling values of each to-be-recommended service for the M indicators are acquired by using one or more of sampling policies such as an ϵ-greedy algorithm, an upper confidence boundary (UCB) algorithm, a Thompson sampling algorithm, and a Monte Carlo sampling algorithm. That is, in each sampling, each to-be-recommended service may correspond to M indicator sampling values.

Indicator types of the M indicators set for the N to-be-recommended services may be the same or different. This is not limited in the disclosure. The indicator types involved in some embodiments may include, but are limited to, a rate type and an average type. The rate-type indicator may reflect an effect of the to-be-recommended service. The rate-type indicator may include, but is not limited to, a click-through rate, a conversion rate, and the like. The click-through rate may be a ratio of a number of clicks of the to-be-recommended service to a total number of pushes. The average-type indicator may reflect an overall satisfaction level of the registered object with the to-be-recommended service, or resources or costs to push the to-be-recommended service. The average-type indicator may include average browsing duration, a number of clicks, an average benefit, an average transaction fee, and the like. The average benefit may be an average value of ratios of the number of times that the to-be-recommended service is purchased, subscribed, or clicked by the registered object to the total number of pushes.

The M indicators of the to-be-recommended service may be M rate-type indicators. For example, the indicators corresponding to the to-be-recommended service may be a click-through rate, a conversion rate, and the like. Alternatively, the M indicators of the to-be-recommended service may be M average-type indicators. For example, the indicators corresponding to the to-be-recommended service may be an average transaction fee, average browsing duration, and the like. Alternatively, the M indicators of the to-be-recommended service may include both the rate-type indicator and the average-type indicator. For example, the indicators corresponding to the to-be-recommended service may be a conversion rate, an average transaction fee, and the like. The M indicators involved in some embodiments may be in a positive correlation, such as a conversion rate and an average browsing duration. Alternatively, the M indicators may be in a negative correlation, such as a conversion rate and an average transaction fee. Each of the N to-be-recommended services has a same indicator.

In a possible implementation, an indicator sampling value of each of the N to-be-recommended services for the M indicators may be acquired by using an ϵ-greedy algorithm. It is assumed that the M indicators corresponding to the N to-be-recommended services include two indicators, for example, a number of clicks and an average benefit. A process of acquiring M indicator sampling values corresponding to a to-be-recommended service i is described below by taking any one of the N to-be-recommended services as an example (such as the to-be-recommended service i).

An indicator sampling value of the to-be-recommended service i for the indicator, for example, the number of clicks, may be denoted as N(i), and an indicator sampling value of the to-be-recommended service i for the indicator, for example, the average benefit, may be denoted as Q(i). The indicator sampling value N(i) and the indicator sampling value Q(i) that correspond to the to-be-recommended service i may be initialized. For example, the indicator sampling value N(i) and the indicator sampling value Q(i) may both be initialized to 0 (for example, N(i)=0, and Q(i)=0). Further, a value ϵ is selected as a first random probability, for example, a probability of exploring unknown information, and a value 1−ϵ is selected as a second random probability, for example, a probability of exploiting known information. In other words, the trade-off between exploration and exploitation may be controlled based on the first random probability ϵ. ϵ is a value greater than 0 and less than 1, and a value thereof may be determined according to an actual situation. Generally, a smaller value of ϵ indicates a higher tendency for the algorithm to perform exploitation. A larger value of ϵ indicates a higher tendency for the algorithm to perform exploration.

The to-be-recommended service i may be sampled at least once based on the first random probability ϵ, and a probability g(i) that the to-be-recommended service i is selected is calculated. g(i)=ϵ/y+[(1−ϵ)/y]I(i), where y is a total completed sampling time, and I(i) is an indication function. When the to-be-recommended service i is a to-be-recommended service having a currently known highest average reward value in the N to-be-recommended services, a value of I(i) is 1, which indicates that the to-be-recommended service i is selected for exploitation. When the to-be-recommended service i is not the to-be-recommended service with the currently known average reward value in the N to-be-recommended services, the value of I(i) is 0, which indicates that another to-be-recommended service is selected for exploration or exploitation.

After the to-be-recommended service i is sampled once, the indicator sampling value corresponding to the to-be-recommended service i may be updated according to an obtained reward value R. A number of times that the to-be-recommended service i is selected may be increased by 1 (N(i)+=1), and the average reward value of the to-be-recommended service i is updated (Q(i)=Q(i)*(N(i)−1)/N(i)+R/N(i)). Further, a next round of sampling may be performed on the to-be-recommended service i according to the updated indicator sampling value. A same processing process as that of the foregoing sampling may be adopted, and the indicator sampling value continues to be updated. Sampling is stopped until a sampling termination condition is satisfied. An indicator sampling value obtained after the last sampling is taken as the indicator sampling value corresponding to the to-be-recommended service i. The sampling ending condition may be that specified sampling time is reached, or the like.

In a possible implementation, the process of acquiring the M indicator sampling values corresponding to the to-be-recommended service i may include: a first probability distribution corresponding to the M indicators may be constructed. The first probability distribution may be understood as a prior distribution of indicators of the to-be-recommended service. The first probability distribution may be a Beta distribution, a normal distribution, or the like. In some embodiments, types of the first probability distributions corresponding to the indicators may be the same or different. For example, when the indicator is a click-through rate or a conversion rate, a corresponding first probability distribution may be a Beta distribution. When the indicator is average browsing duration, a corresponding first probability distribution may be a normal distribution. For ease of understanding, in some embodiments, a process of acquiring an indicator sampling value of the to-be-recommended service for the j^{th} indicator is described by using an example in which the N to-be-recommended services include a to-be-recommended service 1, a to-be-recommended service 2, and a to-be-recommended service 3, the j^{th} indicator is any one of the M indicators, and a first probability distribution corresponding to the j^{th} indicator is a Beta distribution. For a process of acquiring an indicator sampling value corresponding to another indicator, refer to the process of acquiring the indicator sampling value corresponding to the j^{th} indicator. j is a positive integer less than or equal to M, and a value of j may be 2, 3, 4, . . . , or M.

FIG. 4 is a schematic diagram of correction of a probability distribution according to some embodiments. As shown in FIG. 4, a first probability distribution 1 corresponding to the to-be-recommended service 1, a first probability distribution 2 corresponding to the to-be-recommended service 2, and a first probability distribution 3 corresponding to the to-be-recommended service 3 may all be initialized as Beta distributions Beta(α, β). In this case, the first probability distribution 1 may be denoted as Beta1(α, β), the first probability distribution 2 may be denoted as Beta2(α, β), and the first probability distribution 3 may be denoted as Beta3(α, β). The x axis represents a random value, and the y axis represents a probability density of the random value. In the presence of prior experience, initial values of the parameter α and the parameter β may be adjusted. For example, the initial values of the parameter α and the parameter β may both be adjusted to 1.

Further, platform-collected data of the to-be-recommended service 1, the to-be-recommended service 2, and the to-be-recommended service 3 that is related to the j^{th} indicator may be acquired, and further, the first probability distribution corresponding to each to-be-recommended service is corrected according to the platform-collected data, to obtain a second probability distribution corresponding to each to-be-recommended service. The platform-collected data may be understood as a random value obtained through sampling according to the first probability distribution, or may be experimental data obtained through online simulation according to information such as a service attribute of the to-be-recommended service, or may be a push feedback result (such as a number of historical clicks, a historical conversion rate, historical average browsing duration, or a historical average transaction fee) collected after each to-be-recommended service is pushed on the service platform for a period of time. The second probability distribution may be understood as a posterior distribution of the j^{th} indicator. Types of the second probability distribution and the first probability distribution are the same. For example, if the first probability distribution is a Beta distribution, the second probability distribution is also a Beta distribution.

A process of correcting the first probability distribution is described by using an example in which the j^{th} indicator is a number of clicks. For example, the platform-collected data corresponding to the to-be-recommended service 1 is a predicted number of clicks 1, the platform-collected data corresponding to the to-be-recommended service 2 is a predicted number of clicks 2, and the platform-collected data corresponding to the to-be-recommended service 3 is a predicted number of clicks 3. A selected to-be-recommended service may be determined by comparing the predicted number of clicks 1, the predicted number of clicks 2, and the predicted number of clicks 3. For example, if the predicted number of clicks 2 and the predicted number of clicks 3 are both less than the predicted number of clicks 1, it may be determined that the to-be-recommended service 1 is selected, and the to-be-recommended service 2 and the to-be-recommended service 2 are not selected. In this case, the parameter α of Beta1(α, β) (the first probability distribution 1) may be updated according to a comparison result. For example, the parameter α of Beta1(α, β) is increased by 1, to obtain a second probability distribution 1 corresponding to the to-be-recommended service 1. The second probability distribution 1 may be denoted as Beta11(α+1, β). The parameter β of Beta2(α, β) (the first probability distribution 2) and the parameter β of Beta3(α, β) (the first probability distribution 3) may be updated. For example, the parameter B of Beta2(α, β) and the parameter β of Beta3(α, β) are respectively increased by 1, to obtain a second probability distribution 2 corresponding to the to-be-recommended service 2 and a second probability distribution 3 corresponding to the to-be-recommended service 3. The second probability distribution 2 may be denoted as Beta22(α, β+1), and the second probability distribution 3 may be denoted as Beta33(α, β+1). In some embodiments, when the platform-collected data includes a plurality of groups of data, the first probability distribution may be corrected for a plurality of times, and the second probability distribution may better meet expectation through a plurality of corrections.

As shown in FIG. 4, after the first probability distributions are corrected at least once, shapes of the obtained second probability distributions become narrower, which indicates that compared with the first probability distributions, the second probability distributions have higher confidence. Therefore, accuracy of an indicator sampling value obtained by subsequent sampling according to the second probability distribution is relatively high. After the second probability distribution corresponding to each to-be-recommended service is obtained, a random probability value may be acquired from the second probability distribution. It is assumed that a random probability value A is randomly selected from the second probability distribution 1, a random probability value B is randomly selected from the second probability distribution 2, and a random probability value C is randomly selected from the second probability distribution 3. In this case, the random probability value A may be determined as an indicator sampling value of the to-be-recommended service 1 for the j^{th} indicator, the random probability value B may be determined as an indicator sampling value of the to-be-recommended service 2 for the j^{th} indicator, and the random probability value C may be determined as an indicator sampling value of the to-be-recommended service 3 for the j^{th} indicator.

In some embodiments, for the N to-be-recommended services, a first probability distribution (a prior distribution) corresponding to each of the M indicators may be constructed, to quantize influence of each indicator. Further, the first probability distribution is corrected according to the platform-collected data, whereby the confidence of the second probability distribution is improved. Therefore, the accuracy of the indicator sampling value obtained by sampling according to the second probability distribution is relatively high, and then reliability and accuracy of a subsequent traffic allocation proportion may be ensured.

Operation S102: Acquire recommendation probabilities corresponding to the N to-be-recommended services if the M indicator sampling values corresponding to the to-be-recommended service all satisfy a recommendation constraint, and determine a first traffic allocation proportion corresponding to the N to-be-recommended services according to a proportion of the recommendation probability corresponding to each to-be-recommended service in an accumulated recommendation probability corresponding to the N to-be-recommended services.

The recommendation constraint may be understood as a constraint that the to-be-recommended service may satisfy for various indicators, or an experimental design rule that the to-be-recommended service may follow when the to-be-recommended service is recommended. The M indicator sampling values corresponding to each of the N to-be-recommended services may be compared with corresponding recommendation constraints. If the M indicator sampling values corresponding to one or more of the N to-be-recommended services satisfy the recommendation constraints, the operation of acquiring recommendation probabilities corresponding to the N to-be-recommended services is performed. For example, the N to-be-recommended services may include a to-be-recommended service 1 and a to-be-recommended service 2. If M indicator sampling values corresponding to the to-be-recommended service 1 all satisfy the recommendation constraint, and the to-be-recommended service 2 has an indicator sampling value that does not satisfy the recommendation constraint, the operation of acquiring recommendation probabilities corresponding to the N to-be-recommended services is still performed.

In some embodiments, the recommendation constraint associated with the N to-be-recommended services may be designed in advance. When the recommendation constraint is designed, different recommendation constraints may be designed for different indicators. In other words, different indicators may correspond to different recommendation constraints. For example, a recommendation constraint corresponding to an indicator 1 may be designed as that “an indicator sampling value corresponding to the indicator 1 satisfies the recommendation constraint when greater than or equal to 0, and otherwise does not satisfy the recommendation constraint”. A recommendation constraint corresponding to an indicator 2 may be designed as that “an indicator sampling value corresponding to the indicator 2 satisfies the recommendation constraint when greater than or equal to 5%, and otherwise does not satisfy the recommendation constraint”. For a to-be-recommended service (such as the to-be-recommended service 1), in a case that indicator sampling values corresponding to all indicators satisfy corresponding recommendation constraints, it may be determined that the indicator sampling values corresponding to the to-be-recommended service 1 satisfy the recommendation constraints. If the to-be-recommended service 1 has an indicator sampling value that does not satisfy the recommendation constraint, it may be determined that the indicator sampling value corresponding to the to-be-recommended service 1 does not satisfy the recommendation constraint.

When the recommendation constraint is designed for the indicator corresponding to the to-be-recommended service, each of the M indicators associated with the N to-be-recommended services may be converted into a sub-constraints. a is a positive integer, and a value of a may be 1, 2, 3, 4, or the like. In other words, a recommendation constraint corresponding to one indicator may include one or more sub-constraints, and each of the M indicators associated with one to-be-recommended service corresponds to at least one sub-constraint. For example, the indicator 1 may correspond to a sub-constraint C₁ and a sub-constraint C₂, and the indicator 2 may correspond to a sub-constraint C₃. For ease of understanding, in some embodiments, a process of converting the j^{th} indicator into a sub-constraints is described by taking any indicator (such as the j^{th} indicator) corresponding to a to-be-recommended service i as an example. For a process of converting another indicator corresponding to the to-be-recommended service i, refer to the process of converting the j^{th} indicator. The to-be-recommended service i is any one of the N to-be-recommended services. For a process of determining sub-constraints corresponding to another to-be-recommended service, refer to the corresponding description of the to-be-recommended service i.

In a possible implementation, a method for designing the recommendation constraint may include: a target value or a target range (such as a minimum value, a maximum value, an average value, or an expected value) corresponding to the j^{th} indicator may be determined, and further, each target value or each target range is converted into a corresponding sub-constraint, to obtain the a sub-constraints corresponding to the j^{th} indicator. For example, a sub-constraint C₁ taking a minimum value as a target may be designed as “Iⱼ≥T1”, where Iⱼ is an indicator sampling value corresponding to the j^{th} indicator, and T1 is the minimum value. A sub-constraint C₂ taking a maximum value as a target may be designed as “Iⱼ≤T2”, where T2 is the maximum value.

In a possible implementation, the method for designing the recommendation constraint may further include: a sub-constraint may be designed according to an indicator type corresponding to the j^{th} indicator. As described above, the indicator type corresponding to the j^{th} indicator may include a rate type and an average type, and different sub-constraints may be set for different indicator types. If the indicator type is a rate type, a first constraint design policy corresponding to the rate type may be acquired, and further, the j^{th} indicator is converted into the a sub-constraints according to the first constraint design policy. If the indicator type is an average type, a second constraint design policy corresponding to the average type may be acquired, and further, the j^{th} indicator is converted into the a sub-constraints according to the second constraint design policy.

An example of the design rule of sub-constraints corresponding to different indicator types provided in some embodiments may be shown in Table 1.

TABLE 1

| | | | Description of sub-constraint determination |
|---|---|---|---|
| | Description | | Indicator sampling value obtained in each |
| | of indicator | | sampling: a value of a control service is |
| Indicator | distribution | Description of | I_{Arm}_{_{control}}; and a value of a |
| type | and sampling | sub-constraint design | to-be-recommended service is I_{Arm}_{ᵢ} |
| Rate | Beta distribution, | The indicator sampling | If a sub-constraint is that the indicator |
| type | and an indicator | value obtained in each | sampling value of the to-be-recommended |
| | sampling value | sample is 0 or 1, with | service ≥ that of the control service, when |
| | obtained in each | only ≤ or ≥ logic | the indicator sampling value I_{Arm}_{ᵢ} ≥ I_{Arm}_{_{control}}, |
| | sampling is 0 or 1 | | the condition is satisfied, and otherwise, |
| | | | the condition is not satisfied |
| Average | Normal distribution, | The indicator sampling | If a sub-constraint is that the indicator |
| type | and an indicator | value is a continuous | sampling value of the to-be-recommended |
| | sampling value | value with ≤ or ≥ logic | service is not less than 1% of that of the |
| | obtained in each | | control service, when the indicator sampling |
| | time is a value x | | value (I_{Arm}_{ᵢ} − I_{Arm}_{_{control}})/I_{Arm}_{_{control}} ≥ 1%, the |
| | | | condition is satisfied, and otherwise, the |
| | | | condition is not satisfied |

As shown in Table 1, a control service may be set for the N to-be-recommended services, and may be a service that has a maximum benefit (a conversion rate, an exposure rate, or the like) in services pushed in the service platform in a past period (such as a past week or a past month). An indicator sampling value of the control service for the j^{th} indicator may be denoted as I_{Arm}_{_{control}}; and an indicator sampling value of a to-be-recommended service i for the j^{th} indicator may be denoted as I_{Arm}_{ᵢ}.

In some embodiments, indicators of different indicator types may have different indicator distributions (which may also be referred to as probability distributions). For example, when an indicator type corresponding to the j^{th} indicator is a rate type (such as a conversion rate), the indicator distribution corresponding to the indicator may be a Beta distribution. An indicator sampling value obtained by sampling the rate-type indicator each time is 0 or 1. Therefore, a design rule of a sub-constraint corresponding to the rate-type indicator only supports use of a logical operator ≤ or ≥. When the indicator type corresponding to the j^{th} indicator is an average type (such as an average transaction fee), an indicator distribution corresponding to the indicator may be a normal distribution. An indicator sampling value obtained by sampling the average-type indicator each time is a value x. For example, the value x may be 0.1, 1, or the like. The indicator sampling value of the average-type indicator may be a continuous value. Therefore, a design rule of a sub-constraint corresponding to the average-type indicator may support use of a logical operator including ≤ or ≥.

As shown in Table 1, as an example, the first constraint design policy may be designed as that “the indicator sampling value I_{Arm}_{ᵢ} of the to-be-recommended service satisfies the sub-constraint when the indicator sampling value I_{Arm}_{ᵢ} is greater than or equal to the indicator sampling value I_{Arm}_{_{control}} corresponding to the control service, and otherwise does not satisfy the sub-constraint”. Correspondingly, a sub-constraint corresponding to the j^{th} indicator may be designed as that “I_{Arm}_{ᵢ} satisfies the sub-constraint when I_{Arm}_{ᵢ}≥I_{Arm}_{_{control}}, and otherwise does not satisfy the sub-constraint”. In some embodiments, the second constraint design policy may be designed as that “the indicator sampling value I_{Arm}_{ᵢ} of the to-be-recommended service satisfies the sub-constraint when the indicator sampling value I_{Arm}_{ᵢ} is not less than 1% of the indicator sampling value I_{Arm}_{_{control}} corresponding to the control service, and otherwise does not satisfy the sub-constraint”. Correspondingly, a sub-constraint corresponding to the j^{th} indicator may be designed as that “I_{Arm}_{ᵢ} satisfies the sub-constraint when (I_{Arm}_{ᵢ}−I_{Arm}_{_{control}})/I_{Arm}_{_{control}}≥1%, and otherwise does not satisfy the sub-constraint”. 1% is only taken as an example for description, and in practical application, another suitable value may be selected according to an actual requirement, such as 2% or 5%.

In some embodiments, indicator types are classified, different constraint design policies are adopted for indicators of different indicator types, and the indicators are targetedly converted into a plurality of sub-constraints according to the different constraint design policies, whereby impact of each indicator on a subsequent traffic allocation proportion may be finely controlled, rationality of a final traffic allocation proportion of each to-be-recommended service is improved, and further, traffic utilization of the N to-be-recommended services may be further improved.

An example of a determining rule of a recommendation constraint provided in some embodiments may be shown in Table 2.

TABLE 2

| | | | | | | | Whether to |
|---|---|---|---|---|---|---|---|
| | Whether to | Whether to | | Whether to | | Whether to | satisfy a |
| | satisfy a sub- | satisfy a sub- | | satisfy a sub- | | satisfy a sub- | recommendation |
| | constraint C₁ | constraint C₂ | . . . | constraint C_{q} | . . . | constraint Cₐ | constraint Cᵣₑₛᵤₗₜ |
| To-be- | 1 | 1 | . . . | 1 | . . . | 1 | 1 |
| recommended | | | | | | | |
| service 1 | | | | | | | |
| To-be- | 1 | 0 | . . . | 0 | . . . | 1 | 0 |
| recommended | | | | | | | |
| service 2 | | | | | | | |
| . . . | . . . | . . . | . . . | . . . | . . . | . . . | . . . |
| To-be- | 1 | 1 | . . . | 1 | . . . | 1 | 1 |
| recommended | | | | | | | |
| service i | | | | | | | |
| . . . | . . . | . . . | . . . | . . . | . . . | . . . | . . . |
| To-be- | 1 | 0 | . . . | 1 | . . . | 1 | 0 |
| recommended | | | | | | | |
| service n | | | | | | | |

In Table 2, a process of determining the recommendation constraint is described by using an example in which the recommendation constraint Cᵣₑₛᵤₗₜ is the recommendation constraint corresponding to the j^{th} indicator. In some embodiments, after the j^{th} indicator sampling value corresponding to each to-be-recommended service is obtained, the j^{th} indicator sampling value may be compared with each of the a sub-constraints, to determine whether the j^{th} indicator sampling value satisfies a single sub-constraint in the a sub-constraints, and if the j^{th} indicator sampling value satisfies the single sub-constraint, a label corresponding to the sub-constraint is marked as 1; or if the j^{th} indicator sampling value does not satisfy the single sub-constraint, the label corresponding to the sub-constraint is marked as 0. When labels corresponding to the a sub-constraints are all 1, a label corresponding to the recommendation constraint Cᵣₑₛᵤₗₜ is marked as 1. In this case, the j^{th} indicator sampling value corresponding to the to-be-recommended service satisfies the recommendation constraint Cᵣₑₛᵤₗₜ corresponding to the j^{th} indicator. If any one of the a sub-constraints has a label of 0, the label corresponding to the constraint Cᵣₑₛᵤₗₜ is marked as 0. In this case, the j^{th} indicator sampling value corresponding to the to-be-recommended service does not satisfy the recommendation constraint Cᵣₑₛᵤₗₜ corresponding to the j^{th} indicator. The j^{th} indicator sampling value is an indicator sampling value of the to-be-recommended service for the j^{th} indicator.

That is, when the j^{th} indicator sampling values satisfy a sub-constraint C₁, a sub-constraint C₂, . . . , a sub-constraint C_{q}, . . . , and a sub-constraint Cₐ, the j^{th} indicator sampling value corresponding to the to-be-recommended service satisfies the recommendation constraint Cᵣₑₛᵤₗₜ corresponding to the j^{th} indicator. When the j^{th} indicator sampling value does not satisfy one or more of the a sub-constraints (for example, the j^{th} indicator sampling value does not satisfy the sub-constraint C₂, or the j^{th} indicator sampling value does not satisfy the sub-constraint C₂ and the sub-constraint C_{q}), the j^{th} indicator sampling value corresponding to the to-be-recommended service does not satisfy the recommendation constraint Cᵣₑₛᵤₗₜ corresponding to the j^{th} indicator. The sub-constraint C_{q} indicates the q^{th} sub-constraint in the a sub-constraints, and q is a positive integer less than or equal to a. As shown in Table 2, the j^{th} indicator sampling value I_{Arm}_{₁} corresponding to a to-be-recommended service 1 and the j^{th} indicator sampling value I_{Arm}_{ᵢ} corresponding to a to-be-recommended service i satisfy the recommendation constraint Cᵣₑₛᵤₗₜ corresponding to the j^{th} indicator. The j^{th} indicator sampling value I_{Arm}_{₂} corresponding to the to-be-recommended service 2 and the j^{th} indicator sampling value I_{Arm}_{_{N}} corresponding to a to-be-recommended service N do not satisfy the recommendation constraint Cᵣₑₛᵤₗₜ corresponding to the j^{th} indicator.

In some embodiments, an indicator sampling value corresponding to one indicator is compared with one or more sub-constraints corresponding to the indicator, and if the indicator sampling value corresponding to the indicator satisfies each corresponding sub-constraint, it is considered that the indicator sampling value satisfies a recommendation constraint, and otherwise does not satisfy the recommendation constraint. Whether the indicator sampling value satisfies the condition may be accurately determined by this determination method, whereby rationality of the final traffic allocation proportion of each to-be-recommended service may be improved, and further traffic utilization of the N to-be-recommended services may be improved.

The recommendation probability may be understood as a probability that a to-be-recommended service is a best service when the recommendation constraint is satisfied. The accumulated recommendation probability may be understood as a sum of probabilities that the to-be-recommended services are best services when the recommendation constraint is satisfied. In other words, after the recommendation probability corresponding to each to-be-recommended service is calculated, the recommendation probabilities corresponding to the to-be-recommended services are summed to obtain the accumulated recommendation probability.

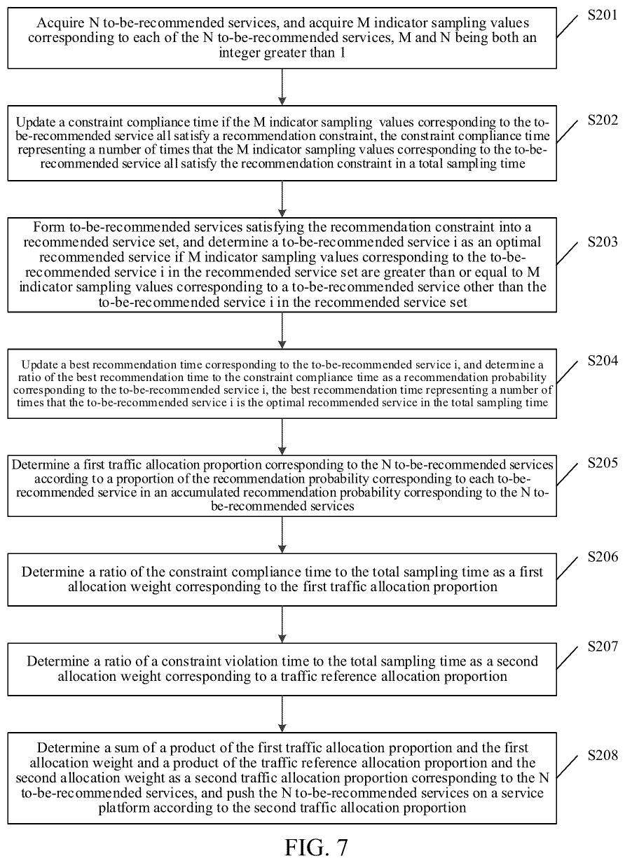

In some embodiments, each to-be-recommended service is sampled for a plurality of times. For each to-be-recommended service, after each sampling is completed, M indicator sampling values may be obtained. The M indicator sampling values obtained after each sampling is completed may not be completely the same. Therefore, for indicator sampling values corresponding to the N to-be-recommended services obtained through two different samplings, a case that M indicator sampling values corresponding to at least one to-be-recommended service satisfy the recommendation constraint may occur in one sampling, and an indicator sampling value of each to-be-recommended service does not satisfy the recommendation constraint in the other sampling. In addition, when sampling batches are different, to-be-recommended services that satisfy the recommendation constraint may be different. For example, in the first sampling, indicator sampling values corresponding to a to-be-recommended service 1 and a to-be-recommended service 2 satisfy the recommendation constraint, and in the second sampling, an indicator sampling value corresponding to a to-be-recommended se rvice 3 satisfies the recommendation constraint. Therefore, when sampling is performed for a plurality of times, an indicator sampling value obtained after each sampling may be compared with the recommendation constraint, to determine whether the recommendation probability corresponding to the to-be-recommended service satisfying the recommendation constraint may be calculated for this sampling. A method for calculating the recommendation probability is described in detail in operation S204 in FIG. 7.

The first traffic allocation proportion may be a weight proportion determined according to a proportion of the recommendation probability corresponding to each to-be-recommended service in the accumulated recommendation probability corresponding to the N to-be-recommended services. The first traffic allocation proportion may be taken as a basis for subsequently setting push policies corresponding to the N to-be-recommended services. Generally, a larger recommendation probability corresponding to the to-be-recommended service indicates a larger first traffic allocation proportion corresponding to the to-be-recommended service, and correspondingly, a larger recommendation traffic allocated to the to-be-recommended service.

The method for calculating a first traffic allocation proportion corresponding to a to-be-recommended service i is described by taking any one (such as the to-be-recommended service i) of the N to-be-recommended services as an example. After a recommendation probability (which may be denoted as P(Arm_{i(Best)})) corresponding to the to-be-recommended service i and the accumulated recommendation probability corresponding to the N to-be-recommended services (which may be denoted as ΣⱼⁿP(Arm_{i(Best)})), the first traffic allocation proportion Uᵢ₍ₜ₎ corresponding to the to-be-recommended service i may be calculated, where Uᵢ₍ₜ₎=P(Arm_{i(Best)})/ΣⱼⁿP(Arm_{i(Best)}). In other words, a ratio of the recommendation probability Arm_{i(Best)} corresponding to the to-be-recommended service i to the accumulated recommendation probability ΣⱼⁿP(Arm_{i(Best)}) corresponding to the N to-be-recommended service is determined as the first traffic allocation proportion Uᵢ₍ₜ₎ corresponding to the to-be-recommended service i.

Operation S103: Perform weighted summation on the first traffic allocation proportion and the traffic reference allocation proportion, to obtain a second traffic allocation proportion corresponding to the N to-be-recommended services, and push the N to-be-recommended services on a service platform according to the second traffic allocation proportion.

In some embodiments, the traffic reference allocation proportion may be understood as a traffic allocation proportion adopted by the N to-be-recommended services when each to-be-recommended service has an indicator sampling value that does not satisfy the recommendation constraint. The second traffic allocation proportion may be understood as a traffic allocation proportion adopted by the N to-be-recommended services when the service is finally pushed in the service platform. When the traffic reference allocation proportion is 0, the second traffic allocation proportion is the first traffic allocation proportion. In this case, the N to-be-recommended services may be pushed in the service platform according to the first traffic allocation proportion. In some embodiments, the traffic reference allocation proportion may be set according to a service expert rule. For example, the N to-be-recommended services include a to-be-recommended service i and a to-be-recommended service j, and it is estimated according to prior knowledge that a conversion rate of the to-be-recommended service i on the service platform is three times that of the to-be-recommended service j. In this case, a traffic reference allocation proportion corresponding to the to-be-recommended service i may be set to 0.75, and a traffic reference allocation proportion corresponding to the to-be-recommended service j may be set to 0.25.

Further, a first allocation weight corresponding to the first traffic allocation proportion and a second allocation weight corresponding to the traffic reference allocation proportion may be acquired, and weighted summation is performed on the first traffic allocation proportion and the traffic reference allocation proportion according to the first allocation weight and the second allocation weight, to obtain the second traffic allocation proportion corresponding to the N to-be-recommended services. Values of the first allocation weight and the second allocation weight may be set according to a service expert rule. An allocation weight corresponding to each allocation proportion may be determined according to an evaluation opinion of an expert on the first traffic allocation proportion and the traffic reference allocation proportion. For example, if it is determined according to prior knowledge that the importance of the first traffic allocation proportion is five times that of the traffic reference allocation proportion, the first allocation weight may be set to 5, and the second allocation weight may be set to 1.

Further, recommendation traffic corresponding to each of the N to-be-recommended services may be determined according to the second traffic allocation proportion, and further, a delivery area range and delivery duration that correspond to each to-be-recommended service are determined according to the recommendation traffic. The N to-be-recommended services are pushed on the service platform according to the delivery area range and the delivery duration.

The recommendation traffic is a basis for measuring delivery information such as a delivery object range, delivery duration, and a number of deliveries that correspond to the to-be-recommended service. Generally, a larger second traffic allocation proportion corresponding to the to-be-recommended service indicates larger recommendation traffic corresponding to the to-be-recommended service. The total recommendation traffic provided by the service platform for the N to-be-recommended services may be acquired, and further, the recommendation traffic corresponding to each to-be-recommended service is determined according to the second traffic allocation proportion corresponding to each to-be-recommended service and the total recommendation traffic. It is assumed that total recommendation traffic provided by the service platform includes 1000 pushes and push duration of 100 minutes, the N to-be-recommended services include a to-be-recommended service 1, a to-be-recommended service 2, and a to-be-recommended service 3, and second traffic allocation proportions thereof are 0.5, 0.3, and 0.2, respectively. The to-be-recommended service 1 may obtain recommendation traffic of 500 pushes and push duration of 50 minutes, the to-be-recommended service 2 may obtain recommendation traffic of 300 pushes and push duration of 30 minutes, and the to-be-recommended service 3 may obtain recommendation traffic of 200 pushes and push duration of 20 minutes.

In some embodiments, a registered object set may be acquired from the service platform, historical login information and object information of each registered object in the registered object set are acquired, and the historical login information and the object information are both converted into vector features, to obtain an object feature corresponding to each registered object. Further, service attribute information corresponding to each to-be-recommended service may be converted into a vector feature, to obtain a service feature corresponding to each to-be-recommended service.

The object feature may represent an attribute and a characteristic that are related to a registered object, and may be configured to distinguish a difference between different registered objects. Similarly, the service feature may represent an attribute and a characteristic of the to-be-recommended service, and may be configured to distinguish a difference between different to-be-recommended services. After the object feature corresponding to each registered object and the service feature corresponding to each to-be-recommended service are obtained, similarities between the service features corresponding to the to-be-recommended services and the object features corresponding to the registered object may be calculated in sequence. For example, similarity between a service feature corresponding to a to-be-recommended service 1 and the object features corresponding to the registered object may be respectively calculated, and similarities between a service feature corresponding to a to-be-recommended service 2 and the object features corresponding to the registered object are respectively calculated until the service features corresponding to the N to-be-recommended services are traversed. In some embodiments, the similarity between the service feature and the object feature may be calculated by using one or more of methods such as a Euclidean distance, a Manhattan distance, a Minkowski distance, and a cosine similarity.

A method for determining a delivery area range and delivery duration that correspond to a to-be-recommended service i is described by taking any one (such as to-be-recommended service i) of the N to-be-recommended services as an example. Registered objects corresponding to object features whose similarities are greater than a similarity threshold may be combined into a candidate delivery range corresponding to the to-be-recommended service i, and the delivery area range of the to-be-recommended service i is determined in the candidate delivery range according to recommendation traffic corresponding to the to-be-recommended service i. The similarity threshold is a preset parameter, and a value may be determined according to an actual situation. The candidate delivery range may be understood as a range formed by target audiences associated with the to-be-recommended service on the service platform. The delivery area range may be understood as a range formed by delivery objects corresponding to the to-be-recommended service when the to-be-recommended service is finally pushed on the service platform. Generally, the candidate delivery range is greater than or equal to the delivery area range. It is assumed that the candidate delivery range includes 1000 registered objects, and the recommendation traffic corresponding to the to-be-recommended service i is 500 pushes, 500 registered objects whose similarities are ranked top may be selected from the 1000 registered objects, and are determined as the delivery area range of the to-be-recommended service i. Total delivery duration corresponding to the N to-be-recommended services may be acquired, and the delivery duration corresponding to the to-be-recommended service i is determined according to the recommendation traffic corresponding to the to-be-recommended service i. For example, the total delivery duration is 100 minutes, the recommendation traffic corresponding to the to-be-recommended service i is push duration of 50 minutes, and a second traffic allocation proportion corresponding to the to-be-recommended service i is 50%. In this case, the delivery duration corresponding to the to-be-recommended service i is set to 50 minutes. Further, the to-be-recommended service i may be pushed to the corresponding registered object on the service platform according to the delivery area range and the delivery duration that correspond to the to-be-recommended service i.

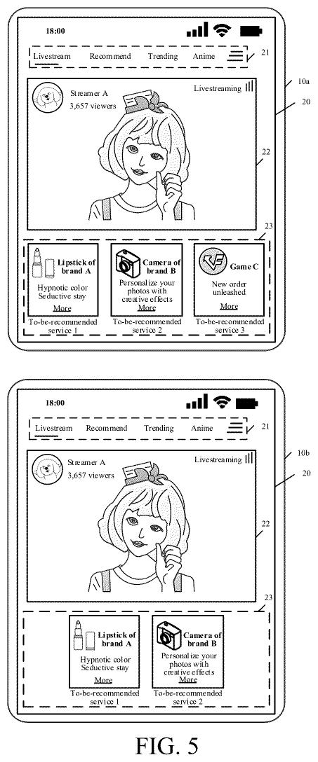

FIG. 5 is a schematic diagram of an interface for pushing a service according to some embodiments. A displaying interface for pushing a service on a service platform is described by using an example in which the service platform is a video client, and the pushed service includes a to-be-recommended service 1, a to-be-recommended service 2, and a to-be-recommended service 3. As shown in FIG. 5, a use object corresponding to a terminal device 10a is a registered object 1, and a use object corresponding to a terminal device 10b is a registered object 2. When the registered object 1 or the registered object 2 has a video playback requirement, a video client 20 may be triggered on the terminal device. The terminal device displays a video display interface corresponding to the video client 20 in response to the trigger operation for the video client 20. The video display interface may include a menu bar 21, and the registered object may select, by triggering a livestreaming control in the menu bar 21, any livestreaming room to watch a livestreaming. For example, the registered object may trigger a livestreaming room 22 to watch a livestreaming related to a streamer A. At the same time, the video client 20 may further push some to-be-recommended services to the registered object in a service push area 23. A larger second traffic allocation proportion corresponding to the to-be-recommended service indicates larger obtained recommendation traffic, and correspondingly, indicates a larger obtained delivery area range of the to-be-recommended service 1 on the video client 20. It is assumed that it is determined, according to the second traffic allocation proportion corresponding to each to-be-recommended service, that a delivery area range corresponding to a to-be-recommended service 1 includes a registered object 1 and a registered object 2, a delivery area range corresponding to a to-be-recommended service 2 includes the registered object 1 and the registered object 2, and a delivery area range corresponding to a to-be-recommended service 3 includes the registered object 1, as shown in FIG. 5, the to-be-recommended service 1 and the to-be-pushed service 2 may be synchronously pushed to the registered object 1 and the registered object 2 in the service push area 23 of the video client 20. The to-be-recommended service 3 is pushed to the registered object 1 in the service push area 23 of the video client 20, but the to-be-recommended service 3 is not pushed to the registered object 2.

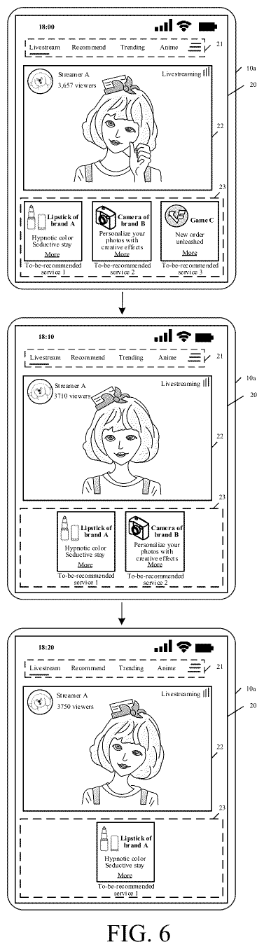

FIG. 6 is a schematic diagram of another interface for pushing a service according to some embodiments. As shown in FIG. 6, a use object corresponding to a terminal device 10a is a registered object 1. A larger second traffic allocation proportion corresponding to the to-be-recommended service indicates larger obtained recommendation traffic, and correspondingly, indicates longer delivery duration of the to-be-recommended service 1 on a video client 20. It is assumed that the video client 20 pushes the to-be-recommended service 1, the to-be-recommended service 2, and the to-be-recommended service 3 to the registered object 1 within a time period of 18:00 to 18:30. It is determined, according to the second traffic allocation proportion corresponding to each to-be-recommended service, that delivery duration corresponding to the to-be-recommended service 1 is 30 minutes, delivery duration corresponding to the to-be-recommended service 2 is 20 minutes, and delivery duration corresponding to the to-be-recommended service 3 is 10 minutes. As shown in FIG. 6, when system time is “18:00”, the to-be-recommended service 1, the to-be-recommended service 2, and the to-be-recommended service 3 may be synchronously pushed to the registered object 1 in a service push area 23 of the video client 20. When the system time is “18:10”, pushing of the to-be-recommended service 3 may be canceled in the service push area 23, and the to-be-recommended service 1 and the to-be-recommended service 2 are pushed to the registered object 1. When the system time is “18:20”, pushing of the to-be-recommended service 2 may be stopped in the service push area 23, and the to-be-recommended service 1 is pushed to the registered object 1.

In some embodiments, after the N to-be-recommended services and the M indicator sampling values corresponding to each to-be-recommended service are acquired, the M indicator sampling values associated with the N to-be-recommended services may be compared with the recommendation constraint. If the M indicator sampling values corresponding to one or more of the N to-be-recommended services satisfy the recommendation constraint, the recommendation probability of each to-be-recommended service on the premise that the recommendation constraint is satisfied may be acquired. Further, the first traffic allocation proportion of each to-be-recommended service on the premise that the recommendation constraint is satisfied may be determined according to the recommendation probability. Weighted summation is performed on the first traffic allocation proportion and the traffic reference allocation proportion (the traffic allocation proportion of each to-be-recommended service on the premise that the recommendation constraint is not satisfied), to obtain a final traffic allocation proportion of each to-be-recommended service. In a process of allocating traffic to the N to-be-recommended services, a plurality of indicators are set for the N to-be-recommended services, and a corresponding recommendation constraint may be configured for each indicator. The plurality of indicators and the recommendation constraint corresponding to each indicator are taken as comprehensive considerations in traffic allocation, whereby rationality of the final traffic allocation proportion of each to-be-recommended service may be improved, and further, traffic utilization of the N to-be-recommended services may be improved.

FIG. 7 is a schematic flowchart of another service data processing method according to some embodiments. The data processing method is performed by a computer device, and the computer device may be a terminal device (such as the terminal device 10a, the terminal device 10b, and the terminal device 10c in some embodiments corresponding to FIG. 1), or a server (such as the server 10d in some embodiments corresponding to FIG. 1). As shown in FIG. 7, the service data processing method may include operation S201 to operation S208.

Operation S201: Acquire N to-be-recommended services, and acquire M indicator sampling values corresponding to each of the N to-be-recommended services, M and N being each an integer greater than 1.

For some embodiments of operation S201, refer to the implementation of operation S101 in FIG. 3. Details are not described herein again.

Operation S202: Update a constraint compliance time if the M indicator sampling values corresponding to the to-be-recommended service all satisfy a recommendation constraint, the constraint compliance time representing a number of times that the M indicator sampling values corresponding to the to-be-recommended service all satisfy the recommendation constraint in a total sampling time.

The total sampling time may be understood as a total number of times that indicator sampling is performed on the N to-be-recommended services, and the total sampling time may be denoted as Time₍ₛ₎. After each sampling is completed, the total sampling time may be increased by 1 (Time₍ₛ₎+=1), to update the total sampling time Time₍ₛ₎. The total sampling time may be set according to an actual situation. For example, the total sampling time is set to 1000, or is set to 10000. This is not limited in some embodiments. In these sampling, indicator sampling values of some to-be-recommended services may satisfy the recommendation constraint, or each to-be-recommended service may have an indicator sampling value that does not satisfy the recommendation constraint. The constraint compliance time records the number of indicator sampling values that satisfy the recommendation constraint in these sampling. The constraint compliance time may be denoted as Time₍ₜ₎. After each sampling is completed, the M indicator sampling values associated with the N to-be-recommended services may be compared with the recommendation constraint. If the M indicator sampling values corresponding to at least one to-be-recommended service satisfy the recommendation constraint, this sampling passes the constraint. In this case, the constraint compliance time may be increased by 1 (Time₍ₜ₎+=1), to update the constraint compliance time Time₍ₜ₎.

Operation S203: Form to-be-recommended services satisfying the recommendation constraint into a recommended service set, and determine a to-be-recommended service i as a best recommended service if M indicator sampling values corresponding to the to-be-recommended service i in the recommended service set are greater than or equal to M indicator sampling values corresponding to a to-be-recommended service other than the to-be-recommended service i in the recommended service set.

The best recommended service may be understood as a to-be-recommended service that satisfies the recommendation constraint and that has a highest indicator sampling value in the recommended service set. In some possible implementations, the best recommended service may be considered as a “best arm” in a multi-armed bandit (MAB) problem. In other words, the best recommended service may be considered as an arm having a highest average return rate in the MAB. The MAB problem is one of classic problems of reinforcement learning, which aims to maximize benefits (EE trade-off) in the policy of exploration of potential high benefits and exploitation of known high benefits.

In one sampling, the to-be-recommended services satisfying the recommendation constraint may be added to the recommended service set, whereby the to-be-recommended services included in the recommended service set are all to-be-recommended services satisfying the recommendation constraint. In some embodiments, the best recommended service may be determined from the recommended service set through Pareto Optimality. For example, the recommended service set includes a to-be-recommended service i, a to-be-recommended service j, and a to-be-recommended service k, and if M indicator sampling values {I_{1(Arm}_{ᵢ}₎, I_{2(Arm}_{ᵢ}₎, . . . , I_{j(Arm}_{ᵢ}₎, . . . , I_{M(Arm}_{ᵢ}₎} corresponding to the to-be-recommended service i are all greater than or equal to indicator sampling values {I_{1(Arm}_{ⱼ}₎, I_{2(Arm}_{ⱼ}₎, . . . , I_{j(Arm}_{ⱼ}₎, . . . , I_{M(Arm}_{ⱼ}₎} corresponding to the to-be-recommended service j, and the indicator sampling values {I_{1(Arm}_{ⱼ}₎, I_{2(Arm}_{ⱼ}₎, . . . , I_{j(Arm}_{ⱼ}₎, . . . , I_{M(Arm}_{ⱼ}₎} corresponding to the to-be-recommended service i are also greater than or equal to indicator sampling values {I_{1(Arm}_{ₖ}₎, I_{2(Arm}_{ₖ}₎, . . . , I_{j(Arm}_{ₖ}₎, . . . , I_{M(Arm}_{ₖ}₎} corresponding to the to-be-recommended service k, the to-be-recommended service i may be determined as a best recommended service in this sampling. When the indicator sampling values corresponding to the to-be-recommended services that are in the recommended service set and that satisfy the recommendation constraint are compared, indicator sampling values corresponding to a same indicator are compared, and indicator sampling values corresponding to different indicators are not compared.

If one or more of the M indicator sampling values corresponding to the to-be-recommended service i are less than the indicator sampling values corresponding to the to-be-recommended service j (for example, I_{1(Arm}_{ᵢ}₎<I_{1(Arm}_{ⱼ}₎), one or more of the M indicator sampling values corresponding to the to-be-recommended service j are less than the indicator sampling values corresponding to the to-be-recommended service k (for example, I_{2(Arm}_{ⱼ}₎<I_{2(Arm}_{ₖ}₎), and one or more of the M indicator sampling values corresponding to the to-be-recommended service k are less than indicator sampling values corresponding to the to-be-recommended service i (for example, I_{3(Arm}_{ₖ}₎<I_{3(Arm}_{ᵢ}₎), it may be determined that the M indicator sampling values corresponding to any to-be-recommended service in the recommended service set are not greater than or equal to the M indicator sampling values corresponding to a remaining to-be-recommended service in the recommended service set. In this case, when the best recommended service is determined from the recommended service set through Pareto Optimality, a unique best recommended service cannot be determined. In this case, all of the to-be-recommended services (including the to-be-recommended service i, the to-be-recommended service j, and the to-be-recommended service k) included in the recommended service set may be determined as best recommended services, and at the same time, a best recommendation time corresponding to the to-be-recommended service included in the recommended service set is updated. For a method for updating the best recommendation time corresponding to the to-be-recommended service included in the recommended service set, refer to the method for updating the best recommendation time corresponding to the to-be-recommended service i in operation S204. Details are not described herein again.

In some embodiments, when a unique best recommended service cannot be determined, the to-be-recommended service included in the recommended service set is taken as the best recommended service, to improve searching efficiency and rationality of the best recommended service, which helps improve calculation efficiency of the final traffic allocation proportion of each to-be-recommended service on the premise that rationality of the final traffic allocation proportion of each to-be-recommended service is not affected.

Operation S204: Update a best recommendation time corresponding to the to-be-recommended service i, and determine a ratio of the best recommendation time to the constraint compliance time as a recommendation probability corresponding to the to-be-recommended service i, the best recommendation time representing a number of times that the to-be-recommended service i is the best recommended service in the total sampling time.

In some embodiments, the best recommendation time corresponding to the to-be-recommended service i may be denoted as T_{Best(Arm}_{ᵢ}₎. After one sampling is completed, if in this sampling, the to-be-recommended service i is determined as the best recommended service, the best recommendation time corresponding to the to-be-recommended service i may be increased by 1 (T_{Best(Arm}_{ᵢ}₎+=1). After the total sampling time is reached, a recommendation probability P(Arm_{i(Best)}) corresponding to the to-be-recommended service i may be calculated according to the constraint compliance time Time₍ₜ₎ and the best recommendation time T_{Best(Arm}_{ᵢ}₎ corresponding to the to-be-recommended service i, where P(Arm_{i(Best)})=T_{Best(Arm}_{ᵢ}₎/Time₍ₜ₎. In other words, a ratio of the best recommendation time T_{Best(Arm}_{ᵢ}₎ corresponding to the to-be-recommended service i to the constraint compliance time Time₍ₜ₎ may be determined as the recommendation probability P(Arm_{i(Best)}) corresponding to the to-be-recommended service i. A method for calculating a recommendation probability corresponding to another to-be-recommended service in the N to-be-recommended services is similar to the calculation method corresponding to the to-be-recommended service i.

In some embodiments, when the recommendation probabilities of the N to-be-recommended services are calculated, only probabilities corresponding to a plurality of to-be-recommended services that satisfy the recommendation constraint corresponding to each indicator may be calculated. Therefore, calculation efficiency of the recommendation probability can be improved, which helps improve calculation efficiency of a final traffic allocation proportion of each to-be-recommended service.

Operation S205: Determine a first traffic allocation proportion corresponding to the N to-be-recommended services according to a proportion of the recommendation probability corresponding to each to-be-recommended service in an accumulated recommendation probability corresponding to the N to-be-recommended services.

For some embodiments of operation S205, refer to the implementation of operation S102 in FIG. 3. Details are not described herein again.

Operation S206: Determine a ratio of the constraint compliance time to the total sampling time as a first allocation weight corresponding to the first traffic allocation proportion.

Operation S207: Determine a ratio of a constraint violation time to the total sampling time as a second allocation weight corresponding to a traffic reference allocation proportion.

In some embodiments, the constraint violation time is updated if each to-be-recommended service has an indicator sampling value that does not satisfy the recommendation constraint. As described above, in a plurality of sampling processes, indicator sampling values of some to-be-recommended services may satisfy the recommendation constraint, or each to-be-recommended service may have an indicator sampling value that does not satisfy the recommendation constraint. The constraint violation time records a number of times that each to-be-recommended service has an indicator sampling value that does not satisfy the recommendation constraint in these sampling. The constraint violation time may be denoted as Time_{(w)}. In addition, the constraint violation time Time_{(w)} may be understood as a difference between the total sampling time Time₍ₛ₎ and the constraint compliance time Time₍ₜ₎. In other words, the constraint violation time may also be represented as Time_{(w)}=Time₍ₛ₎−Time₍ₜ₎. After each sampling is completed, the M indicator sampling values associated with the N to-be-recommended services may be compared with the recommendation constraint. If each to-be-recommended service has an indicator sampling value that does not satisfy the recommendation constraint, this sampling fails to pass the constraint. In this case, the constraint violation time may be increased by 1 (Time₍ₛ₎+=1), to update the constraint violation time Time₍ₛ₎.

Further, M indicator constraint weights corresponding to the to-be-recommended service i in the N to-be-recommended services may be acquired. Each of the M indicators has an indicator constraint weight, and indicator constraint weights corresponding to different indicators may be the same or different. The indicator constraint weight may be set according to a service expert rule. For example, an indicator constraint weight corresponding to each indicator may be determined according to an evaluation opinion of an expert on each indicator. For example, if it is considered, according to prior knowledge, that importance of an indicator 1 is twice that of an indicator 2, an indicator constraint weight of the indicator 1 may be set to 2, and an indicator constraint weight of the indicator 2 may be set to 1. Alternatively, a contribution of each indicator may be determined by using a statistical model (such as a regression model), to derive a corresponding indicator constraint weight.

Weighted summation is performed on the M indicator sampling values corresponding to each to-be-recommended service and the M indicator constraint weights, to obtain a recommendation evaluation value corresponding to each to-be-recommended service. The recommendation evaluation value may be understood as a comprehensive indicator of weighted averaging. For example, a recommendation evaluation value D_{(Arm}_{ᵢ}₎ corresponding to a to-be-recommended service i may be calculated, where D_{(Arm}_{ᵢ}₎=W₍ᵢ₁₎*I_{1(Arm}_{ᵢ}₎+W₍ᵢ₂₎*I_{2(Arm}_{ᵢ}₎. W₍ᵢ₁₎ may be understood as an indicator constraint weight corresponding to an indicator 1 of the to-be-recommended service i, an I_{1(Arm}_{ᵢ}₎ may be understood as an indicator sampling value of the to-be-recommended service i for the indicator 1. W₍ᵢ₂₎ may be understood as an indicator constraint weight corresponding to an indicator 2 of the to-be-recommended service i, and I_{2(Arm}_{ᵢ}₎ may be understood as an indicator sampling value of the to-be-recommended service i for the indicator 2. Similarly, a recommendation evaluation value D_{(Arm}_{ⱼ}₎ corresponding to a to-be-recommended service j and a recommendation evaluation value D_{(Arm}_{ₖ}₎ corresponding to a to-be-recommended service k may be calculated. If the recommendation evaluation value D_{(Arm}_{ᵢ}₎ corresponding to the to-be-recommended service i is greater than or equal to the recommendation evaluation value D_{(Arm}_{ⱼ}₎ corresponding to the to-be-recommended service j, and is greater than or equal to the recommendation evaluation value D_{(Arm}_{ₖ}₎ corresponding to the to-be-recommended service k, the to-be-recommended service i may be determined as a candidate recommended service. The candidate recommended service may be understood as a to-be-recommended service corresponding to a maximum recommendation evaluation value in a case that the N to-be-recommended services have indicator sampling values that do not satisfy the recommendation constraint in one sampling.

Further, candidate recommendation time corresponding to the to-be-recommended service i may be updated, and a ratio of the candidate recommendation time to the constraint violation time is determined as a reference allocation probability corresponding to the to-be-recommended service i. The candidate recommendation time represents the number of times that the to-be-recommended service i is a candidate recommended service in the total sampling time. In some embodiments, the candidate recommendation time corresponding to the to-be-recommended service i may be denoted as T_{cand(Arm}_{ᵢ}₎. After one sampling is completed, if in this sampling, the to-be-recommended service i is determined as the candidate recommended service, the candidate recommendation time corresponding to the to-be-recommended service i may be increased by 1 (T_{cand(Arm}_{ᵢ}₎+=1). After the total sampling time is reached, the reference allocation probability P(Arm_{i(cand)}) corresponding to the to-be-recommended service i may be calculated according to the constraint violation time Time_{(w)} and the candidate recommendation time T_{cand(Arm}_{ᵢ}₎ that correspond to the to-be-recommended service i, where P(Arm_{i(cand)})=T_{cand(Arm}_{ᵢ}₎/Time_{(w)}. In other words, a ratio of the candidate recommendation time T_{cand(Arm}_{ᵢ}₎ corresponding to the to-be-recommended service i to the constraint violation time Time_{(w)} is determined as the reference allocation probability P(Arm_{i(cand)}) corresponding to the to-be-recommended service i. A method for calculating a reference allocation probability corresponding to another to-be-recommended service in the N to-be-recommended services is similar to the calculation method corresponding to the to-be-recommended service i.

Further, the traffic reference allocation proportion corresponding to the N to-be-recommended services may be determined according to a proportion of the reference allocation probability corresponding to each to-be-recommended service in an accumulated reference allocation probability corresponding to the N to-be-recommended services. The accumulated reference allocation probability may be understood as a sum of probabilities that the to-be-recommended services are selected in a case that the recommendation constraint is not satisfied. In other words, after the reference allocation probability corresponding to each to-be-recommended service is calculated, the reference allocation probabilities corresponding to the to-be-recommended services are summed to obtain the accumulated reference allocation probability. A method for calculating a traffic reference allocation proportion corresponding to the to-be-recommended service i is described by taking any one (such as the to-be-recommended service i) of the N to-be-recommended services as an example. After the reference allocation probability P(Arm_{i(cand)} corresponding to the to-be-recommended service i and the accumulated reference allocation probability ΣⱼⁿP(Arm_{i(cand)}) corresponding to the N to-be-recommended services are obtained, the traffic reference allocation proportion U_{i(c)} corresponding to the to-be-recommended service i may be calculated, where U_{i(c)}=P(Arm_{i(cand)})/ΣⱼⁿP(Arm_{i(cand)}). In other words, a ratio of the reference allocation probability P(Arm_{i(cand)} corresponding to the to-be-recommended service i to the accumulated recommendation probability ΣⱼⁿP(Arm_{i(Best)}) corresponding to the N to-be-recommended services is determined as the traffic reference allocation proportion U_{i(c)} corresponding to the to-be-recommended service i.

In some embodiments, a first allocation weight corresponding to the first traffic allocation proportion may be denoted as W₍ₜ₎, where W₍ₜ₎=Time₍ₜ₎/Time₍ₛ₎. In other words, a ratio of the constraint compliance time Time₍ₜ₎ to the total sampling time Time₍ₛ₎ is determined as the first allocation weight W₍ₜ₎. Similarly, a second allocation weight corresponding to the traffic reference allocation proportion may be denoted as W_{(c)}, where W_{(c)}=Time_{(w)}/Time₍ₛ₎. In other words, a ratio of the constraint violation time Time_{(w)} to the total sampling time Time₍ₛ₎ is determined as the second allocation weight W_{(c)}. In some embodiments, the second allocation weight W_{(c)} may further be represented as W_{(c)}=1−W₍ₜ₎.

Operation S208: Determine a sum of a product of the first traffic allocation proportion and the first allocation weight and a product of the traffic reference allocation proportion and the second allocation weight as a second traffic allocation proportion corresponding to the N to-be-recommended services, and push the N to-be-recommended services on a service platform according to the second traffic allocation proportion.

In some embodiments, the first traffic allocation proportion may be denoted as Uᵢ₍ₜ₎, the traffic reference allocation proportion is denoted as U_{i(c)}, and the second traffic allocation proportion is denoted as Uᵢ, where Uᵢ=W₍ₜ₎*Uᵢ₍ₜ₎+W_{(c)}*U_{i(c)}. In other words, the sum of the product of the first traffic allocation proportion Uᵢ₍ₜ₎ and the first allocation weight W₍ₜ₎ and the product of the traffic reference allocation proportion U_{i(c)} and the second allocation weight W_{(c)} is determined as the second traffic allocation proportion Uᵢ corresponding to the N to-be-recommended services. For a method for pushing the N to-be-recommended services on the service platform, refer to the description of operation S103. Details are not described herein again.

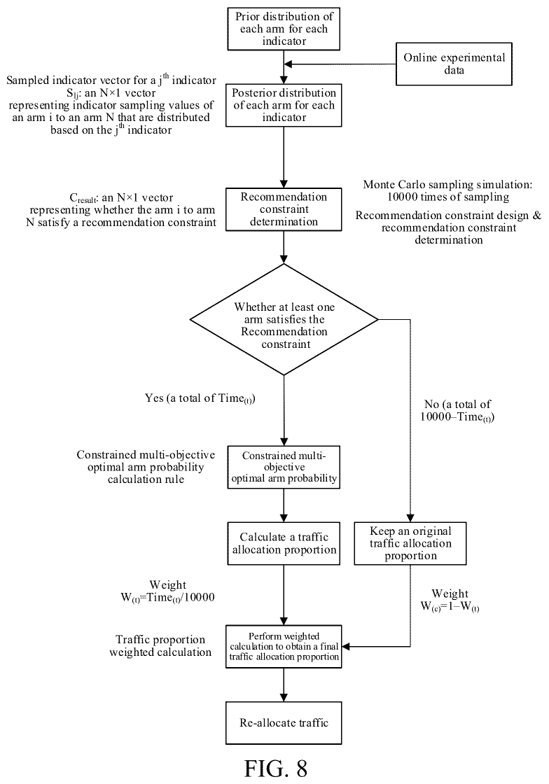

FIG. 8 is a schematic diagram of calculation of a traffic proportion according to some embodiments. As shown in FIG. 8, some embodiments mainly involve calculation of a traffic allocation proportion corresponding to each arm in a combinatorial multi-objective (M>1)-Thompson Sampling-MAB (CMO-TS-MAB). Some embodiments are also applicable to a traffic allocation scenario with single-objective (M=1) optimization. The MAB may include N+1 groups of arms, and may include one control group of arms and N groups of experimental arms. The control group of arms herein may be understood as the control service mentioned above, and the N groups of experimental arms may be understood as the N to-be-recommended services mentioned above. In addition, unless otherwise specified, in some embodiments, when an “arm” is separately mentioned, it is considered by default that the “arm” is a group of experimental arms. Each arm corresponds to M indicators. In other words, each arm corresponds to M indicator sampling values.

As shown in FIG. 8, a prior distribution of each of the M indicators for each arm may be first initialized, and further, the prior distribution of each indicator for each arm is corrected according to online experimental data, to obtain a posterior distribution of each indicator for each arm The prior distribution herein may be understood as the first probability distribution mentioned above, the online experimental data may be understood as the platform-collected data mentioned above, and the posterior distribution may be understood as the second probability distribution. For a correction method, refer to the foregoing description of operation S101. Details are not described herein again. In some embodiments, the total sampling time may be set to 10000, and the M indicator sampling values corresponding to each arm may be obtained by using a Monte Carlo sampling policy. For a method for designing a recommendation constraint, refer to the foregoing description of operation S102. Details are not described herein again.

When whether an indicator sampling value corresponding to at least one of an arm i to an arm N in the N arms satisfies the recommendation constraint Cᵣₑₛᵤₗₜ corresponding to the j^{th} indicator (any one of the M indicators) is determined, an indicator sampling value Iᵢ of each arm for the j^{th} indicator may be converted into a sampled indicator vector S_{I}_{ⱼ}, where S_{I}_{ⱼ} is an N×1 vector, and indicates indicator sampling values of the arm i to the arm N in the N arms that are distributed based on the j^{th} indicator. Cᵣₑₛᵤₗₜ is also an N×1 vector, and indicates whether the arm i to the arm N in the N arms satisfy the recommendation constraint. Further, a weighted sample vector S′_{I}_{ⱼ}=S_{I}_{ⱼ}⊙Cᵣₑₛᵤₗₜ corresponding to each arm for the j^{th} indicator is calculated, where ⊙ represents a Hadamard product operation. The Hadamard product operation is also referred to as element-by-element product or matrix point product, and refers to a new matrix or vector obtained by performing multiplication on elements in two matrices or vectors having a same dimension one by one according to element locations. Further, whether the indicator sampling value corresponding to at least one of the arm i to arm N in the N arms satisfies the recommendation constraint Cᵣₑₛᵤₗₜ corresponding to the j^{th} indicator may be determined according to a value of the weighted sample vector S′_{I}_{ⱼ}. When the value of the weighted sample vector S′_{I}_{ⱼ} is 1, the indicator sampling value corresponding to at least one of the arm i to the arm N in the N arms satisfies the recommendation constraint Cᵣₑₛᵤₗₜ corresponding to the j^{th} indicator. When the value of the weighted sample vector S′_{I}_{ⱼ} is 0, all of the arm i to the arm N in the N arms have indicator sampling values that do not satisfy the recommendation constraint Cᵣₑₛᵤₗₜ.

As shown in FIG. 8, after 10000 times of sampling are completed, the number of times that the recommendation constraint is satisfied (which may also be referred to as the constraint compliance time) and the number of times that the recommendation constraint is not satisfied (which may also be referred to as the constraint violation time) are statistically collected. For example, the constraint compliance time may be Time₍ₜ₎, and the constraint violation time may be (10000−Time₍ₜ₎). If the constraint is satisfied in one sampling, a best arm may be determined from the arms satisfying the recommendation constraint. After 10000 times of sampling are completed, a best arm probability of each arm is calculated, and a traffic allocation proportion is calculated according to the best arm probability of each arm. The best arm herein may be understood as the best recommended service mentioned above, the best arm probability may be understood as the recommendation probability mentioned above, and the traffic allocation proportion may be understood as the first traffic allocation proportion Uᵢ₍ₜ₎ designed above. For a method for acquiring the best arm, the best arm probability, and the traffic allocation proportion in some embodiments, refer to the description of operation S205. Details are not described herein again. After 10000 times of sampling are completed, an original traffic allocation proportion may be calculated according to the constraint violation time. The original traffic allocation proportion herein may be understood as the traffic reference allocation proportion U_{i(c)} mentioned above. For a method for calculating the original traffic allocation ratio in some embodiments, refer to the description of operation S207. Details are not described herein again. Further, a weight (the weight W₍ₜ₎=Time₍ₜ₎/10000) corresponding to the traffic allocation proportion is calculated, and a weight (the weight W_{(c)}=1−W₍ₜ₎) corresponding to the original traffic allocation proportion are calculated. Finally, a final traffic allocation proportion of each arm is determined through weighted summation, and traffic is re-allocated to each arm according to the final traffic allocation proportion. The final traffic allocation proportion herein may be understood as the second traffic allocation proportion Uᵢ mentioned above. For a method for calculating the final traffic allocation proportion in some embodiments, refer to the description of operation S208. Details are not described herein again.

The method for determining the traffic allocation proportions of the plurality of to-be-recommended services involved in some embodiments may be applied to various recommendation scenarios. To validate an effect of the traffic allocation solution (which may be referred to as this solution for ease of description) corresponding to the plurality of to-be-recommended services provided in some embodiments, this solution and a single-objective-TS-MAB may be applied to delivery of a traffic product of XX communication company, and delivery duration on a service platform is 20XX.XX.03 to 20XX.XX.08. A transaction conversion rate and an average cost are taken as indicators in this solution, and the single-objective-TS-MAB adopts the average cost as an indicator. In this solution and a control group of the single-objective-TS-MAB, a traffic product with a largest transaction volume in a same period in the last month or a traffic product recommended by a service expert rule is selected. Performance effects of this solution and the single-objective-TS-MAB are shown in Table 3.

TABLE 3

| | | Relative | |
|---|---|---|---|
| | | increase- | Relative |
| | | transaction | increase-average |
| | | conversion | commission per |
| Province | Algorithm/indicator | rate (%) | person (%) |
| XX traffic | Single-objective-TS- | −3.61 | 1.53 |
| product in | MAB (average cost) | | |
| A Province | This solution | 0.64 | 16.92 |
| XX traffic | Single-objective-TS- | −1.54 | −1.89 |
| product in | MAB (average cost) | | |
| B Province | This solution | 3.66 | 23.25 |
| XX traffic | Single-objective-TS- | 9.01 | 6.99 |
| product in | MAB (average cost) | | |
| C Province | This solution | 17.91 | 44.66 |

It can be seen from Table 3 that, compared with the single-target-TS-MAB, this solution has positively improved effects on both the transaction conversion rate and the average costs, which indicates that this solution may improve traffic utilization of each traffic product, and further, improves a delivery effect of each traffic product. In addition, the transaction conversion rate and the average cost are two indicators that are negatively correlated with each other. The foregoing results indicate that this solution also achieves a good effect when applied to a recommendation scenario in which optimization targets are negatively correlated with each other.

In some embodiments, in a process of allocating traffic to the N to-be-recommended services, a plurality of indicators are set for the N to-be-recommended services, and a corresponding recommendation constraint may be configured for each indicator. The plurality of indicators and the recommendation constraint corresponding to each indicator are taken as comprehensive considerations in traffic allocation, whereby rationality of a final traffic allocation proportion of each to-be-recommended service may be improved, and further, traffic utilization of the N to-be-recommended services may be improved.

In some embodiments of the disclosure, relevant information (such as login information and information of the user on the service platform) of a user on the service platform may be involved. When the foregoing embodiments of the disclosure are applied to a product or technology, the permission or consent of the user may be required, and the collection, use, and processing of relevant data may comply with relevant laws and regulations and standards of relevant countries and regions.

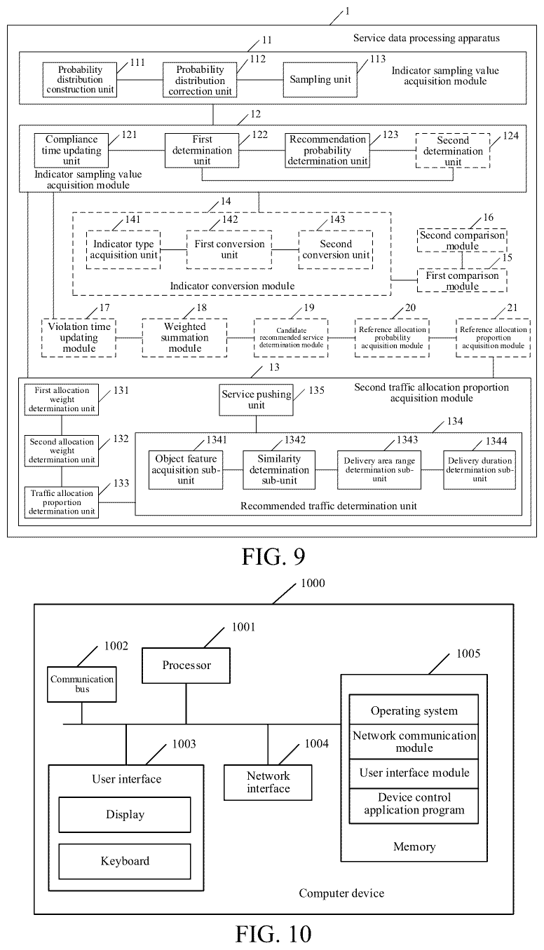

FIG. 9 is a schematic structural diagram of a service data processing apparatus according to some embodiments. The service data processing apparatus may be applied to the server 10d or the terminal device (such as the terminal device 10a) shown in FIG. 1. As shown in FIG. 9, a data service processing apparatus 1 may include: an indicator sampling value acquisition module 11, a first traffic allocation proportion acquisition module 12, and a second traffic allocation proportion acquisition module 13.

The indicator sampling value acquisition module 11 is configured to acquire N to-be-recommended services, and acquire M indicator sampling values corresponding to each of the N to-be-recommended services, M and N being each an integer greater than 1.

The first traffic allocation proportion acquisition module 12, configured to acquire recommendation probabilities corresponding to the N to-be-recommended services if the M indicator sampling values corresponding to the to-be-recommended service all satisfy a recommendation constraint, and determine a first traffic allocation proportion corresponding to the N to-be-recommended services according to a proportion of the recommendation probability corresponding to each to-be-recommended service in an accumulated recommendation probability corresponding to the N to-be-recommended services.

The second traffic allocation proportion acquisition module 13 is configured to perform weighted summation on the first traffic allocation proportion and a traffic reference allocation proportion, to obtain a second traffic allocation proportion corresponding to the N to-be-recommended services, and push the N to-be-recommended services on a service platform according to the second traffic allocation proportion,
the traffic reference allocation proportion being a traffic allocation proportion adopted by the N to-be-recommended services when each to-be-recommended service has an indicator sampling value that does not satisfy the recommendation constraint.

For implementations of the functions of the indicator sampling value acquisition module 11, the first traffic allocation proportion acquisition module 12, and the second traffic allocation proportion acquisition module 13, refer to operation S101 to operation S103 in the foregoing embodiment corresponding to FIG. 3. Details are not described herein again.

In some possible implementations, the indicator sampling value acquisition module 11 includes: a probability distribution construction unit 111, a probability distribution correction unit 112, and a sampling unit 113.

The probability distribution construction unit 111 is configured to acquire M indicators associated with the N to-be-recommended services, and construct a first probability distribution corresponding to the j^{th} indicator in the M indicators, j being a positive integer less than or equal to M.

The probability distribution correction unit 112 is configured to acquire platform-collected data corresponding to the j^{th} indicator, and correct the first probability distribution according to the platform-collected data, to obtain a second probability distribution.

The sampling unit 113 is configured to sample each of the N to-be-recommended services according to the second probability distribution, to obtain an indicator sampling value of each to-be-recommended service for the j^{th} indicator.

For implementations of the functions of the probability distribution construction unit 111, the probability distribution correction unit 112, and the sampling unit 113, refer to operation S101 in the foregoing embodiment corresponding to FIG. 3. Details are not described herein again.

In some possible implementations, the service data processing apparatus 1 may further include: an indicator conversion module 14, a first comparison module 15, and a second comparison module 16.

The indicator conversion module 14 is configured to convert each of the M indicators associated with the N to-be-recommended services into a sub-constraints, a being a positive integer.

The first comparison module 15 is configured to determine that the j^{th} indicator sampling value of a to-be-recommended service i satisfies a recommendation constraint corresponding to the j^{th} indicator if the j^{th} indicator sampling value of the to-be-recommended service i satisfies a sub-constraints corresponding to the j^{th} indicator, the to-be-recommended service i belonging to the N to-be-recommended services, the j^{th} indicator sampling value being an indicator sampling value of the to-be-recommended service i for the j^{th} indicator, different indicators corresponding to different recommendation constraints, and j being a positive integer less than or equal to M.

The second comparison module 16 is configured to determine that the to-be-recommended service i does not satisfy the recommendation constraint corresponding to the j^{th} indicator if the j^{th} indicator sampling value of the to-be-recommended service i does not satisfy one or more of the a sub-constraints corresponding to the j^{th} indicator.

For implementations of the functions of the indicator conversion module 14, the first comparison module 15, and the second comparison module 16, refer to operation S102 in the foregoing embodiment corresponding to FIG. 3. Details are not described herein again.

In some possible implementations, the indicator conversion module 14 may further include: an indicator type acquisition unit 141, a first conversion unit 142, and a second conversion unit 143.

The indicator type acquisition unit 141 is configured to acquire an indicator type corresponding to the j^{th} indicator in the M indicators associated with the N to-be-recommended services.

The first conversion unit 142 is configured to acquire a first constraint design policy corresponding to a rate type if the indicator type is the rate type, and convert the j^{th} indicator into the a sub-constraints according to the first constraint design policy.

The second conversion unit 143 is configured to acquire a second constraint design policy corresponding to an average type if the indicator type is the average type, and convert the j^{th} indicator into the a sub-constraints according to the second constraint design policy.

For implementations of the functions of the indicator type acquisition unit 141, the first conversion unit 142, and the second conversion unit 143, refer to operation S102 in the foregoing embodiment corresponding to FIG. 3. Details are not described herein again.

In some possible implementations, the indicator conversion module 14 is configured to:
determine a target value or a target range that correspond to the j^{th} indicator in the M indicators associated with the N to-be-recommended services; and
convert the target value or the target range into a corresponding sub-constraint, to obtain the a sub-constraints corresponding to the j^{th} indicator.

In some possible implementations, the first traffic allocation proportion acquisition module 12 may include: a compliance time updating unit 121, a first determination unit 122, and a recommendation probability determination unit 123.

The compliance time updating unit 121 is configured to update a constraint compliance time if the M indicator sampling values corresponding to the to-be-recommended service all satisfy the recommendation constraint, the constraint compliance time representing a number of times that the M indicator sampling values corresponding to the to-be-recommended service all satisfy the recommendation constraint in a total sampling time.

The first determination unit 122 is configured to form to-be-recommended services satisfying the recommendation constraint into a recommended service set, and determine that the to-be-recommended service i is a best recommended service if M indicator sampling values corresponding to the to-be-recommended service i in the recommended service set are greater than or equal to M indicator sampling values corresponding to a to-be-recommended service other than the to-be-recommended service i in the recommended service set.

The recommendation probability determination unit 123 is configured to update a best recommendation time corresponding to the to-be-recommended service i, and determine a ratio of the best recommendation time to the constraint compliance time as a recommendation probability corresponding to the to-be-recommended service i, the best recommendation time representing a number of times that the to-be-recommended service i is the best recommended service in the total sampling time.

For implementations of the functions of the compliance time updating unit 121, the first determination unit 122, and the recommendation probability determination unit 123, refer to operation S202 to operation S204 in the foregoing embodiment corresponding to FIG. 7. Details are not described herein again.

In some possible implementations, the first traffic allocation proportion acquisition module 12 may further include: a second determination unit 124.

The second determination unit 124 is configured to determine all the to-be-recommended services included in the recommended service set as best recommended services if M indicator sampling values corresponding to any to-be-recommended service in the recommended service set are not greater than or equal to M indicator sampling values corresponding to a remaining to-be-recommended service in the recommended service set, and update the best recommendation time corresponding to the to-be-recommended services included in the recommended service set.

For some embodiments of the function of the second determination unit 124, refer to operation S204 in the foregoing embodiment corresponding to FIG. 7. Details are not described herein again.

In some possible implementations, the service data processing apparatus 1 may further include: a violation time updating module 17, a weighted summation module 18, a candidate recommended service determination module 19, a reference allocation probability acquisition module 20, and a reference allocation proportion acquisition module 21.

The violation time updating module 17 is configured to update a constraint violation time if each to-be-recommended service has an indicator sampling value that does not satisfy the recommendation constraint, the constraint violation time being a difference between the total sampling time and the constraint compliance time.

The weighted summation module 18 is configured to acquire M indicator constraint weights corresponding to the to-be-recommended service i in the N to-be-recommended services, and perform weighted summation on the M indicator sampling values and the M indicator constraint weights that correspond to the to-be-recommended service i, to obtain a recommendation evaluation value corresponding to the to-be-recommended service i.

The candidate recommended service determination module 19 is configured to determine the to-be-recommended service i as the candidate recommended service if the recommendation evaluation value corresponding to the to-be-recommended service i is greater than or equal to a recommendation evaluation value corresponding to a to-be-recommended service other than the to-be-recommended service i in the N to-be-recommended services.

The reference allocation probability acquisition module 20 is configured to update candidate recommendation time corresponding to the to-be-recommended service i, and determine a ratio of the candidate recommendation time to the constraint violation time as a reference allocation probability corresponding to the to-be-recommended service i, the candidate recommendation time representing a number of times that the to-be-recommended service i is the candidate recommended service in the total sampling time.

The reference allocation proportion acquisition module 21 is configured to determine the traffic reference allocation proportion corresponding to the N to-be-recommended services according to a proportion of the reference allocation probability corresponding to each to-be-recommended service in an accumulated reference allocation probability corresponding to the N to-be-recommended services.

For implementations of the functions of the violation time updating module 17, the weighted summation module 18, the candidate recommended service determination module 19, the reference allocation probability acquisition module 20, and the reference allocation proportion acquisition module 21, refer to operation S205 in the foregoing embodiment corresponding to FIG. 7. Details are not described herein again.

In some possible implementations, the second traffic allocation proportion acquisition module 13 may include: a first allocation weight determination unit 131, a second allocation weight determination unit 132, and a traffic allocation proportion determination unit 133.

The first allocation weight determination unit 131 is configured to determine a ratio of the constraint compliance time to the total sampling time as a first allocation weight corresponding to the first traffic allocation proportion.

The second allocation weight determination unit 132 is configured to determine a ratio of the constraint violation time to the total sampling time as a second allocation weight corresponding to the traffic reference allocation proportion.

The traffic allocation proportion determination unit 133 is configured to determine a sum of a product of the first traffic allocation proportion and the first allocation weight and a product of the traffic reference allocation proportion and the second allocation weight as the second traffic allocation proportion corresponding to the N to-be-recommended services.

For implementations of the functions of the first allocation weight determination unit 131, the second allocation weight determination unit 132, and the traffic allocation proportion determination unit 133, refer to operation S206 to operation S208 in the foregoing embodiment corresponding to FIG. 7. Details are not described herein again.

In some possible implementations, the second traffic allocation proportion acquisition module 13 may include: a recommendation traffic determination unit 134 and a service pushing unit 135.

The recommendation traffic determination unit 134 is configured to determine recommendation traffic corresponding to each of the N to-be-recommended services according to the second traffic allocation proportion, and determine a delivery area range and delivery duration that correspond to each to-be-recommended service according to the recommendation traffic.

The service pushing unit 135 is configured to push the N to-be-recommended services on the service platform according to the delivery area range and the delivery duration.

For implementations of the functions of the recommendation traffic determination unit 134 and the service pushing unit 135, refer to operation S103 in the foregoing embodiment corresponding to FIG. 3. Details are not described herein again.

In some possible implementations, the recommendation traffic determination unit 134 may include: an object feature acquisition sub-unit 1341, a similarity determination sub-unit 1342, a delivery area range determination sub-unit 1343, and a delivery duration determination sub-unit 1344.

The object feature acquisition sub-unit 1341 is configured to acquire a registered object set from the service platform, and acquire an object feature corresponding to each registered object in the registered object set.

The similarity determination sub-unit 1342 is configured to acquire a service feature corresponding to the to-be-recommended service i in the N to-be-recommended services, and determine a similarity between the service feature corresponding to the to-be-recommended service i and the object features corresponding to each registered object.

The delivery area range determination sub-unit 1343 is configured to combine registered objects corresponding to object features whose similarities are greater than a similarity threshold into a candidate delivery range corresponding to the to-be-recommended service i, and determine a delivery area range of the to-be-recommended service i in the candidate delivery range according to recommendation traffic corresponding to the to-be-recommended service i.

The delivery duration determination sub-unit 1344 is configured to acquire the total delivery duration corresponding to the N to-be-recommended services, and determine, according to the recommendation traffic corresponding to the to-be-recommended service i, delivery duration corresponding to the to-be-recommended service i.

For implementations of the functions of the object feature acquisition sub-unit 1341, the similarity determination sub-unit 1342, the delivery area range determination sub-unit 1343, and the delivery duration determination sub-unit 1344, refer to operation S103 in the foregoing embodiment corresponding to FIG. 3. Details are not described herein again.

According to some embodiments, the modules in the service data processing apparatus 1 shown in FIG. 9 may be separately or all combined into one or a plurality of units, or one (or more) of the units may be further split into at least two small sub-units by function, which may implement the same operations without affecting the implementation of the technical effects of some embodiments. The foregoing modules are divided based on logical functions. In practical application, a function of one module may be implemented by at least two units, or functions of at least two modules are implemented by one unit. In other embodiments of the disclosure, the service data processing apparatus 1 may further include other units. In practical application, these functions may be cooperatively implemented by other units and may be cooperatively implemented by at least two units.

In some embodiments, after the N to-be-recommended services and the M indicator sampling values corresponding to each to-be-recommended service are acquired, the M indicator sampling values associated with the N to-be-recommended services may be compared with the recommendation constraint. If the M indicator sampling values corresponding to one or more of the N to-be-recommended services satisfy the recommendation constraint, the recommendation probability of each to-be-recommended service on the premise that the recommendation constraint is satisfied may be acquired. Further, the first traffic allocation proportion of each to-be-recommended service on the premise that the recommendation constraint is satisfied may be determined according to the recommendation probability. Weighted summation is performed on the first traffic allocation proportion and the traffic reference allocation proportion (the traffic allocation proportion of each to-be-recommended service on the premise that the recommendation constraint is not satisfied), to obtain a final traffic allocation proportion of each to-be-recommended service. In a process of allocating traffic to the N to-be-recommended services, a plurality of indicators are set for the N to-be-recommended services, and a corresponding recommendation constraint may be configured for each indicator. The plurality of indicators and the recommendation constraint corresponding to each indicator are taken as comprehensive considerations in traffic allocation, whereby rationality of the final traffic allocation proportion of each to-be-recommended service may be improved, and further, traffic utilization of the N to-be-recommended services may be improved.

FIG. 10 is a schematic structural diagram of a computer device according to some embodiments. As shown in FIG. 10, a computer device 1000 may be the server 10d in some embodiments corresponding to FIG. 1, or may be the terminal device 10a in some embodiments corresponding to FIG. 1. This is not limited herein. For ease of understanding, in some embodiments, a description is made by using an example in which the computer device is a terminal device. The computer device 1000 may include: a processor 1001, a network interface 1004, and a memory 1005. In addition, the computer device 1000 may include: a user interface 1003 and at least one communication bus 1002. The communications bus 1002 is configured to implement connection and communication between the components. The user interface 1003 may include a display, a keyboard. In some embodiments, the user interface 1003 may further include a standard wired interface and wireless interface. In some embodiments, the network interface 1004 may include a standard wired interface and wireless interface (such as a wireless fidelity (Wi-Fi) interface). The memory 1005 may be a high-speed random-access memory (RAM), or may be a non-volatile memory, such as at least one magnetic disk memory. In some embodiments, the memory 1005 may be at least one storage apparatus away from the processor 1001. As shown in FIG. 10, as a computer-readable storage medium, the memory 1005 may include an operating system, a network communications module, a user interface module, and a device control application program.

In the computer device 1000 shown in FIG. 10, the network interface 1004 may provide a network communication function. The user interface 1003 may be configured to provide an input interface for a user. The processor 1001 may be configured to invoke the device control application program stored in the memory 1005 to implement:
acquiring N to-be-recommended services, and acquiring M indicator sampling values corresponding to each of the N to-be-recommended services, M and N being each an integer greater than 1;
acquiring recommendation probabilities corresponding to the N to-be-recommended services if the M indicator sampling values corresponding to the to-be-recommended service all satisfy a recommendation constraint, and determining a first traffic allocation proportion corresponding to the N to-be-recommended services according to a proportion of the recommendation probability corresponding to each to-be-recommended service in an accumulated recommendation probability corresponding to the N to-be-recommended services; and
performing weighted summation on the first traffic allocation proportion and a

traffic reference allocation proportion, to obtain a second traffic allocation proportion corresponding to the N to-be-recommended services, and pushing the N to-be-recommended services on a service platform according to the second traffic allocation proportion, the traffic reference allocation proportion being a traffic allocation proportion

adopted by the N to-be-recommended services when each to-be-recommended service has an indicator sampling value that does not satisfy the recommendation constraint.

The computer device 1000 described in some embodiments may implement the descriptions of the service data processing method in the foregoing embodiments corresponding to FIG. 3 and FIG. 7, and may also implement the description of the service data processing apparatus 1 in the foregoing embodiment corresponding to FIG. 9. Details are not described herein again. In addition, beneficial effects achieved by adopting the same method are not described herein again.

In addition, some embodiments provide a computer-readable storage medium in which a computer program executed by the service data processing apparatus 1 mentioned above is stored. The computer program includes program instructions. A processor executes the program instructions to implement the foregoing description of the service data processing method in the foregoing embodiment corresponding to FIG. 3 or FIG. 7. Details are not described herein again. In addition, beneficial effects achieved by adopting the same method are not described herein again. The storage medium may be a magnetic disk, an optical disk, a read-only memory (ROM), an RAM, or the like. For technical details that are not disclosed in some embodiments of the computer-readable storage medium involved in the disclosure, refer to the descriptions of the method embodiments of the disclosure. As an example, the program instructions may be deployed to be executed on one computing device, or on a plurality of computing devices located at one site, or on a plurality of computing devices distributed across a plurality of sites and interconnected through a communication network. The plurality of computing devices distributed across the plurality of sites and interconnected through the communication network may form a blockchain network.

In addition, some embodiments provide a computer program product or computer program, which may include computer instructions. The computer instructions may be stored in a computer-readable storage medium. A processor of a computer device reads the computer instructions from the computer-readable storage medium, and may execute the computer instructions, to cause the computer device to implement the description of the data processing method in some embodiments corresponding to FIG. 3 or FIG. 7. Details are not described herein again. In addition, beneficial effects achieved by adopting the same method are not described herein again. For technical details that are not disclosed in some embodiments of the computer program product or computer program of the disclosure, refer to the descriptions of the method embodiments of the disclosure.

The terms “first” and “second” in the specification, claims, and accompanying drawings of some embodiments are used for distinguishing between different media content, and are not used for describing a sequence. In addition, the terms “include” and any variation thereof are intended to cover a non-exclusive inclusion. For example, a process, method, apparatus, product, or device including a series of operations or units is not limited to the listed operations or modules, but instead, includes operations or modules not listed in some embodiments, or include other operations or units inherent in the process, method, apparatus, product, or device in some embodiments.

Those of ordinary skill in the art may realize that units and algorithm operations of each example described with reference to the disclosed embodiments herein can be implemented by electronic hardware, computer software, or a combination thereof. To clearly describe the interchangeability between the hardware and the software, a composition and operations of each example have been generally described based on functions in the foregoing descriptions. Whether the functions are executed in the form of hardware or software depends on application and design constraints of the technical solutions. Those skilled in the art may adopt different methods to implement the described functions for each application, but such implementation is not to be considered beyond the scope of the disclosure.

The methods and related apparatuses provided in some embodiments are described with reference to the method flowcharts and/or schematic structural diagrams provided in some embodiments. Each flow and/or block in the method flowcharts and/or schematic structural diagrams and a combination of flows and/or blocks in the flowcharts and/or block diagrams may be implemented according to computer program instructions. These computer program instructions may be provided to a general-purpose computer, a dedicated computer, an embedded processor, or a processor of another programmable data processing device to generate a machine, whereby the instructions executed by the computer or the processor of the another programmable data processing device generate an apparatus configured to implement the functions specified in one or more processes of the flowcharts and/or in one or more blocks of the schematic structural diagrams. Alternatively, the computer program instructions may be stored in a computer-readable memory that can guide the computer or the another programmable data processing device to operate in a manner, whereby the instructions stored in the computer-readable memory generate an artifact including an instruction apparatus. The instruction apparatus implements the functions specified in one or more processes of the flowcharts and/or one or more blocks of the schematic structural diagrams. Alternatively, the computer program instructions may be loaded onto the computer or the another programmable data processing device, whereby a series of operations are performed on the computer or the another programmable device to generate processing implemented by the computer. Therefore, the instructions executed on the computer or the another programmable device provide operations for implementing the functions specified in one or more processes of the flowcharts and/or one or more blocks of the schematic structural diagrams.

What is disclosed above is merely exemplary embodiments of the disclosure, and certainly is not intended to limit the scope of the claims of the disclosure. Therefore, equivalent variations made in accordance with the claims of the disclosure still fall within the scope of the disclosure.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A service data processing method, performed by a computer device, the method comprising:
acquiring N services and M indicator sampling values corresponding to the N services, M and N being integers greater than 1;
determining, based on the M indicator sampling values satisfying a recommendation constraint, recommendation probabilities corresponding to the N services;
determining a first traffic allocation proportion corresponding to each of the N services, based on a ratio of the recommendation probability corresponding to each of the N services to a total accumulated recommendation probability corresponding to the N services;
determining a second traffic allocation proportion corresponding to each of the N services based on a weighted summation on the first traffic allocation proportion and a reference allocation proportion; and
pushing the N services on a platform based on the second traffic allocation proportion,
wherein the traffic reference allocation proportion is a traffic allocation proportion adopted by each of the N services based on at least one indicator sampling value not satisfying the recommendation constraint.

2. The method according to claim 1, wherein the acquiring M indicator sampling values comprises:
acquiring M indicators associated with the N services;
constructing a first probability distribution corresponding to the j^{th} indicator in the M indicators, j being a positive integer less than or equal to M;
acquiring platform-collected data corresponding to the j^{th} indicator;
correcting the first probability distribution based on the platform-collected data to obtain a second probability distribution; and
sampling each of the N services based on the second probability distribution to obtain an indicator sampling value of each of the N services for the j^{th} indicator.

3. The method according to claim 1, further comprising:
converting each of the M indicators associated with the N services into a plurality of sub-constraints;
determining that a j^{th} indicator sampling value of an i^{th} service of the N services satisfies a recommendation constraint corresponding to the j^{th} indicator, based on the j^{th} indicator sampling value satisfying all of the plurality of sub-constraints,
wherein different indicators correspond to different recommendation constraints,
wherein j is a positive integer less than or equal to M, and i is a positive integer; and
determining that the i^{th} service does not satisfy the recommendation constraint corresponding to the j^{th} indicator when the j^{th} indicator sampling value of the i^{th} service fails to satisfy one or more of the plurality of sub-constraints corresponding to the j^{th} indicator.

4. The method according to claim 3, wherein the converting comprises:
acquiring an indicator type corresponding to the j^{th} indicator of the M indicators;
acquiring a first constraint design policy corresponding to a rate type, based on the indicator type being the rate type;
converting the j^{th} indicator into the plurality of sub-constraints based on the first constraint design policy;
acquiring a second constraint design policy corresponding to an average type based on the indicator type being the average type; and
converting the j^{th} indicator into the plurality of sub-constraints based on the second constraint design policy.

5. The method according to claim 3, wherein the converting comprises:
determining a target value or a target range that correspond to the j^{th} indicator of the M indicators; and
converting the target value or the target range into a corresponding sub-constraint, to obtain the plurality of sub-constraints corresponding to the j^{th} indicator.

6. The method according to claim 1, wherein the determining the recommendation probabilities corresponding to the N services comprises:
updating a constraint compliance time based on the M indicator sampling values corresponding to a service satisfying the recommendation constraint, the constraint compliance time representing a number of times that the M indicator sampling values satisfy the recommendation constraint during a total sampling time;
forming services satisfying the recommendation constraint into a recommended service set;
determining an i^{th} service of the N services as a best recommended service based on M indicator sampling values corresponding to the i^{th} service in the recommended service set being greater than or equal to M indicator sampling values corresponding to other services in the recommended service set; and
updating a best recommendation time corresponding to the i^{th} service, and determining a ratio of the best recommendation time to the constraint compliance time as a recommendation probability corresponding to the i^{th} service, the best recommendation time representing a number of times that the i^{th} service is determined as the best recommended service during the total sampling time.

7. The method according to claim 6, further comprising:
determining all services in the recommended service set as best recommended services based on no single service having M indicator sampling values that are greater than or equal to M indicator sampling values of all other services in the recommended service set; and
updating the best recommendation time corresponding to each of the services determined as best recommended services.

8. The method according to claim 6, further comprising:
updating a constraint violation time based on each of the N services having at least one indicator sampling value that does not satisfy the recommendation constraint, the constraint violation time representing a difference between the total sampling time and the constraint compliance time;
acquiring M indicator constraint weights corresponding to the i^{th} service of the N services;
performing weighted summation on M indicator sampling values corresponding to the i^{th} service and the M indicator constraint weights to obtain a recommendation evaluation value corresponding to the i^{th} service;
determining the i^{th} service as a candidate recommended service based on the recommendation evaluation value corresponding to the i^{th} service being greater than or equal to recommendation evaluation values corresponding to other services in the N services;
updating a candidate recommendation time corresponding to the i^{th} service;
determining a ratio of the candidate recommendation time to the constraint violation time as a reference allocation probability corresponding to the i^{th} service, the candidate recommendation time representing a number of times that the i^{th} service is determined as the candidate recommended service during the total sampling time; and
determining the traffic reference allocation proportion corresponding to each of the N services based on a ratio of the reference allocation probability corresponding to each service to a total accumulated reference allocation probability corresponding to the N services.

9. The method according to claim 1, wherein the determining the second traffic allocation proportion comprises:
determining a first allocation weight corresponding to the first traffic allocation proportion based on a ratio of a constraint compliance time to a total sampling time;
determining a second allocation weight corresponding to the traffic reference allocation proportion based on a ratio of a constraint violation time to the total sampling time; and
determining the second traffic allocation proportion for each of the N services based on a sum of a product of the first traffic allocation proportion and the first allocation weight and a product of the traffic reference allocation proportion and the second allocation weight.

10. The method according to claim 1, wherein the pushing comprises:
determining recommendation traffic corresponding to each of the N services based on the second traffic allocation proportion;
determining a delivery area range and delivery duration for each of the N services based on the recommendation traffic; and
pushing the N services on the platform based on the delivery area range and the delivery duration.

11. The method according to claim 10, wherein the determining a delivery area range and delivery duration comprises:
acquiring a registered object set from the platform;
acquiring an object feature corresponding to each registered object in the registered object set;
acquiring a service feature corresponding to an i^{th} service in the N services;
determining similarities between the service feature corresponding to the i^{th} service and the object features corresponding to the registered objects;
combining registered objects corresponding to object features whose similarities are greater than a similarity threshold into a candidate delivery range corresponding to the i^{th} service;
determining the delivery area range of the i^{th} service within the candidate delivery range based on recommendation traffic corresponding to the i^{th} service; and
acquiring total delivery duration corresponding to the N services, and determining, based on the recommendation traffic corresponding to the i^{th} service, the delivery duration corresponding to the i^{th} service.

12. A service data processing apparatus, comprising:
at least one memory configured to store program code; and
at least one processor configured to read the program code and operate as instructed by the program code, the program code comprising:
acquiring code configured to cause at least one of the at least one processor to acquire N services and M indicator sampling values corresponding to the N services, M and N being integers greater than 1;
determining code configured to cause at least one of the at least one processor to determine, based on the M indicator sampling values satisfying a recommendation constraint, recommendation probabilities corresponding to the N services;
first allocation code configured to cause at least one of the at least one processor to determine a first traffic allocation proportion corresponding to each of the N services, based on a ratio of the recommendation probability corresponding to each of the N services to a total accumulated recommendation probability corresponding to the N services;
second allocation code configured to cause at least one of the at least one processor to determine a second traffic allocation proportion corresponding to each of the N services based on a weighted summation on the first traffic allocation proportion and a reference allocation proportion; and
pushing code configured to cause at least one of the at least one processor to push the N services on a platform based on the second traffic allocation proportion,
wherein the traffic reference allocation proportion is a traffic allocation proportion adopted by each of the N services based on at least one indicator sampling value not satisfying the recommendation constraint.

13. The apparatus according to claim 12, wherein the acquiring code is further configured to cause at least one of the at least one processor to:
acquire M indicators associated with the N services;
construct a first probability distribution corresponding to the j^{th} indicator in the M indicators, j being a positive integer less than or equal to M;
acquire platform-collected data corresponding to the j^{th} indicator;
correct the first probability distribution based on the platform-collected data to obtain a second probability distribution; and
sample each of the N services based on the second probability distribution to obtain an indicator sampling value of each of the N services for the j^{th} indicator.

14. The apparatus according to claim 12, wherein the program code is further configured to cause at least one of the at least one processor to:
convert each of the M indicators associated with the N services into a plurality of sub-constraints;
determine that a j^{th} indicator sampling value of an i^{th} service of the N services satisfies a recommendation constraint corresponding to the j^{th} indicator, based on the j^{th} indicator sampling value satisfying all of the plurality of sub-constraints,
wherein different indicators correspond to different recommendation constraints,
wherein j is a positive integer less than or equal to M, and i is a positive integer; and
determine that the i^{th} service does not satisfy the recommendation constraint corresponding to the j^{th} indicator when the j^{th} indicator sampling value of the i^{th} service fails to satisfy one or more of the plurality of sub-constraints corresponding to the j^{th} indicator.

15. The apparatus according to claim 14, wherein the program code is further configured to cause at least one of the at least one processor to:
acquire an indicator type corresponding to the j^{th} indicator of the M indicators;
acquire a first constraint design policy corresponding to a rate type, based on the indicator type being the rate type;
convert the j^{th} indicator into the plurality of sub-constraints based on the first constraint design policy;
acquire a second constraint design policy corresponding to an average type based on the indicator type being the average type; and
convert the j^{th} indicator into the plurality of sub-constraints based on the second constraint design policy.

16. The apparatus according to claim 14, wherein the program code is further configured to cause at least one of the at least one processor to:
determine a target value or a target range that correspond to the j^{th} indicator of the M indicators; and
convert the target value or the target range into a corresponding sub-constraint, to obtain the plurality of sub-constraints corresponding to the j^{th} indicator.

17. The apparatus according to claim 12, wherein the determining code is further configured to cause at least one of the at least one processor to:
update a constraint compliance time based on the M indicator sampling values corresponding to a service satisfying the recommendation constraint, the constraint compliance time representing a number of times that the M indicator sampling values satisfy the recommendation constraint during a total sampling time;
form services satisfying the recommendation constraint into a recommended service set;
determine an i^{th} service as a best recommended service based on M indicator sampling values corresponding to the i^{th} service in the recommended service set being greater than or equal to M indicator sampling values corresponding to other services in the recommended service set; and
update a best recommendation time corresponding to the i^{th} service, and determine a ratio of the best recommendation time to the constraint compliance time as a recommendation probability corresponding to the i^{th} service, the best recommendation time representing a number of times that the i^{th} service is determined as the best recommended service during the total sampling time.

18. The apparatus according to claim 17, wherein the determining code is further configured to cause at least one of the at least one processor to:
determine all services in the recommended service set as best recommended services based on no single service having M indicator sampling values that are greater than or equal to M indicator sampling values of all other services in the recommended service set; and
update the best recommendation time corresponding to each of the services determined as best recommended services.

19. The apparatus according to claim 17, wherein the determining code is further configured to cause at least one of the at least one processor to:
update a constraint violation time based on each of the N services having at least one indicator sampling value that does not satisfy the recommendation constraint, the constraint violation time representing a difference between the total sampling time and the constraint compliance time;
acquire M indicator constraint weights corresponding to the i^{th} service of the N services;
perform weighted summation on M indicator sampling values corresponding to the i^{th} service and the M indicator constraint weights to obtain a recommendation evaluation value corresponding to the i^{th} service;
determine the i^{th} service as a candidate recommended service based on the recommendation evaluation value corresponding to the i^{th} service being greater than or equal to recommendation evaluation values corresponding to other services in the N services;
update a candidate recommendation time corresponding to the i^{th} service;
determine a ratio of the candidate recommendation time to the constraint violation time as a reference allocation probability corresponding to the i^{th} service, the candidate recommendation time representing a number of times that the i^{th} service is determined as the candidate recommended service during the total sampling time; and
determine the traffic reference allocation proportion corresponding to each of the N services based on a ratio of the reference allocation probability corresponding to each service to a total accumulated reference allocation probability corresponding to the N services.

20. A non-transitory computer-readable storage medium, storing computer code which, when executed by at least one processor, causes the at least one processor to at least:
acquire N services and M indicator sampling values corresponding to the N services, M and N being integers greater than 1;
determine, based on the M indicator sampling values satisfying a recommendation constraint, recommendation probabilities corresponding to the N services;
determine a first traffic allocation proportion corresponding to each of the N services, based on a ratio of the recommendation probability corresponding to each of the N services to a total accumulated recommendation probability corresponding to the N services;
determine a second traffic allocation proportion corresponding to each of the N services based on a weighted summation on the first traffic allocation proportion and a reference allocation proportion; and
push the N services on a platform based on the second traffic allocation proportion,
wherein the traffic reference allocation proportion is a traffic allocation proportion adopted by each of the N services based on at least one indicator sampling value not satisfying the recommendation constraint.
